(19) United States
(12) Patent Application Publication
(10) Pub. No.: US 2023/0412921 A1
(43) Pub. Date: Dec. 21, 2023

(54) IMAGING APPARATUS, INFORMATION PROCESSING METHOD, AND PROGRAM

(71) Applicant: FUJIFILM Corporation, Tokyo (JP)

(72) Inventors: Taro SAITO, Saitama-shi (JP); Takehiro KOGUCHI, Saitama-shi (JP); Shinya FUJIWARA, Saitama-shi (JP); Yukinori NISHIYAMA, Saitama-shi (JP)

(73) Assignee: FUJIFILM Corporation, Tokyo (JP)

(21) Appl. No.: 18/451,127

(22) Filed: Aug. 17, 2023

Related U.S. Application Data
(63) Continuation of application No. PCT/JP2022/000090, filed on Jan. 5, 2022.

(30) Foreign Application Priority Data
Feb. 26, 2021 (JP) 2021-031216

(51) Int. Cl. H04N 23/67; H04N 5/272; H04N 23/63; H04N 23/61; G03B 17/18

(52) U.S. Cl. CPC H04N 23/675; H04N 5/272; H04N 23/672; H04N 23/61; G03B 17/18; H04N 23/635

(57) ABSTRACT

There is provided an imaging apparatus including an image sensor, and a processor, in which the processor is configured to detect a focus region within an imaging area based on imaging data obtained by the image sensor, generate moving image data based on the imaging data obtained by the image sensor, generate information image data representing information related to the moving image data, output the moving image data and the information image data, which is associated with a window region in an image represented by the moving image data, and control a position of the window region according to the focus region.

### CROSS-REFERENCE TO RELATED APPLICATION

This application is a continuation application of International Application No. PCT/JP2022/000090, filed Jan. 5, 2022, the disclosure of which is incorporated herein by reference in its entirety. Further, this application claims priority from Japanese Patent Application No. 2021-031216 filed on Feb. 26, 2021, the disclosure of which is incorporated herein by reference in its entirety.

### BACKGROUND

### 1. Technical Field

The present disclosed technology relates to an imaging apparatus, an information processing method, and a program.

### 2. Description of the Related Art

JP2010-226496A discloses an imaging apparatus including an imaging unit that generates live view image data from an optical image of a subject within an imaging range, an autofocus unit that automatically adjusts a focusing position of the imaging unit, a focus region specifying unit that specifies a region R1 including the focusing position in the live view image data, an image enlarging unit that enlarges sub screen data in the live view image data corresponding to the region R1, a composite region setting unit that sets a disposition of a sub screen such that the sub screen does not overlap the focus region, an image composition unit that combines the sub screen data with the sub screen, and an image output unit that outputs the live view image data that is combined with the sub screen data.

JP2016-004163A discloses a control device including a depth information acquisition unit that acquires depth information about a subject in a captured image and a display processing unit that performs processing of superimposing and displaying the captured image or an image corresponding to the captured image and information for designating a focusing position obtained from the depth information and that changes a display state of information for designating the focusing position according to a relationship between the focusing position and a subject position.

JP2019-169769A discloses an image processing apparatus including an imaging unit that images a subject and a distance map acquisition unit that acquires information, which is related to a distance distribution of the subject, as map data. The distance map acquisition unit acquires the distance map data or map data of an image shift amount or defocus amount associated with a captured image by using a time of flight (TOF) method, an imaging surface phase difference detection method using a pupil-splitting type imaging element, or the like. The image processing unit generates texture image data in which low-frequency components of the captured image are suppressed and generates image data that represents the distance distribution of the subject by combining the texture image data and the map data that is acquired by the distance map acquisition unit.

### SUMMARY

One embodiment according to the present disclosed technology provides an imaging apparatus, an information processing method, and a program that do not require a user to perform a setting operation of a window region and can improve visibility of a focus region.

An imaging apparatus of the present disclosure comprises: an image sensor; and a processor, in which the processor is configured to: detect a focus region within an imaging area based on imaging data obtained by the image sensor; generate moving image data based on the imaging data obtained by the image sensor; generate information image data representing information related to the moving image data; output the moving image data and the information image data, which is associated with a window region in an image represented by the moving image data; and control a position of the window region according to the focus region.

It is preferable that the processor outputs the moving image data and the information image data to a display destination.

It is preferable that the processor disposes the information image data in the window region and outputs composite moving image data generated by combining the moving image data and the information image data.

It is preferable that the processor sets the position of the window region in a region that does not overlap the focus region.

It is preferable that the processor detects the focus region using a part of range within a depth of field as a focus determination range.

It is preferable that a stop is further included, in which the processor sets the focus determination range based on a stop value of the stop.

It is preferable that the processor detects the focus region again using a part of range within a depth of field as a focus determination range in a case where a region, which is equal to or greater than a certain ratio in the image represented by the moving image data, is the focus region.

It is preferable that the processor detects a distance from a subject based on the imaging data and control a state of the window region according to a change direction of the detected distance of the subject.

It is preferable that the processor does not change the position of the window region for a certain period of time in a case where the focus region is changed as at least one subject, which is present within the focus region, is moved in a going-away direction and becomes an out-of-focus state.

It is preferable that the processor erases the window region for a certain period of time or increases a transmittance for a certain period of time in a case where the focus region is changed as at least one subject, which is present within the focus region, is moved in an approaching direction and becomes an out-of-focus state.

It is preferable that the processor does not change the position of the window region for a certain period of time in a case where the focus region is changed as at least one subject, which is not present within the focus region, is moved in an approaching direction and becomes an in-focus state.

It is preferable that the processor changes the position of the window region along an outer periphery of the image represented by the moving image data.

It is preferable that in a case where an icon is displayed in the image represented by the moving image data, the processor moves the window region along a path avoiding the icon or moves the icon outside the path where the window region is moved.

It is preferable that the processor restricts a change direction of the position of the window region to a direction intersecting a stretching direction of the window region in a case where the window region has a shape stretching along one side of the image represented by the moving image data.

It is preferable that the processor does not change the position of the window region while a specific operation is being performed.

It is preferable that the information image data is data obtained by correcting the moving image data, a histogram representing a brightness, or a waveform representing a brightness.

It is preferable that the processor sets the position of the window region to a position overlapping the focus region in a case where the information image data is peaking image data.

It is preferable that the processor changes a size of the window region based on a size of the focus region.

It is preferable that the window region is set at a specific position and is set to a state in which a transmittance is increased in a case where a region, which is equal to or greater than a certain ratio in the image represented by the moving image data, is the focus region, and the window region is not capable of being set to a region that does not overlap the focus region.

It is preferable that the image sensor includes a plurality of phase difference pixels, and the processor detects the focus region based on, among the imaging data, imaging data that is obtained from the phase difference pixel.

It is preferable that the phase difference pixel is capable of selectively outputting non-phase difference image data, which is obtained by performing photoelectric conversion in an entire region of a pixel, and phase difference image data, which is obtained by performing the photoelectric conversion in a part of region of the pixel, and the processor detects the focus region based on imaging data in a case where the phase difference pixel outputs the phase difference image data.

An information processing method of the present disclosure comprises: detecting a focus region within an imaging area based on imaging data obtained by an image sensor; generating moving image data based on the imaging data obtained by the image sensor; generating information image data representing information related to the moving image data; outputting the moving image data and the information image data, which is associated with a window region in an image represented by the moving image data; and controlling a position of the window region according to the focus region.

A program of the present disclosure that causes a computer to execute a process comprises: detecting a focus region within an imaging area based on imaging data obtained by an image sensor; generating moving image data based on the imaging data obtained by the image sensor; generating information image data representing information related to the moving image data; outputting the moving image data and the information image data, which is associated with a window region in an image represented by the moving image data; and controlling a position of the window region according to the focus region.

### BRIEF DESCRIPTION OF THE DRAWINGS

Exemplary embodiments according to the technique of the present disclosure will be described in detail based on the following figures, wherein:

FIG. 1 is a schematic configuration diagram showing an example of a configuration of an entire imaging apparatus,

FIG. 2 is a schematic configuration diagram showing an example of hardware configurations of an optical system and an electrical system of the imaging apparatus,

FIG. 3 is a schematic configuration diagram showing an example of a configuration of a photoelectric conversion element,

FIG. 4 is a block diagram showing an example of a function of a processor,

FIG. 5 is a bird's-eye view of an imaging area obtained by the imaging apparatus as viewed from above,

FIG. 6 is a diagram showing an example of moving image data,

FIG. 7 is a conceptual diagram illustrating an example of information image data generation processing,

FIG. 8 is a conceptual diagram illustrating an example of data output processing,

FIG. 9 is a conceptual diagram illustrating an example of window region position control processing,

FIG. 10 is a flowchart showing an example of a flow of PinP display processing,

FIG. 11 is a block diagram showing an example of a function of a processor according to a first modification example,

FIG. 12 is a conceptual diagram showing an example of a relationship between a depth of field and a focus determination range,

FIG. 13 is a conceptual diagram illustrating an example of focus region detection processing according to the first modification example,

FIG. 14 is a diagram showing an example of a relationship between an F number and the focus determination range,

FIG. 15 is a flowchart showing an example of a flow of the focus region detection processing according to the first modification example,

FIG. 16 is a conceptual diagram illustrating an example of window region position control processing according to a second modification example,

FIG. 17 is a flowchart showing an example of a flow of the window region position control processing according to the second modification example,

FIG. 18 is a conceptual diagram illustrating an example of window region position control processing according to a third modification example,

FIG. 19 is a flowchart showing an example of a flow of the window region position control processing according to the third modification example,

FIG. 20 is a conceptual diagram illustrating an example of window region position control processing according to a fourth modification example,

FIG. 21 is a flowchart showing an example of a flow of the window region position control processing according to the fourth modification example,

FIG. 22 is a conceptual diagram illustrating an example of window region position control processing according to a fifth modification example,

FIG. 23 is a conceptual diagram illustrating an example of window region position control processing according to a sixth modification example,

FIG. 24 is a conceptual diagram illustrating another example of the window region position control processing according to the sixth modification example,

FIG. 25 is a conceptual diagram illustrating an example of window region position control processing according to a seventh modification example,

FIG. 26 is a flowchart showing an example of a flow of window region position control processing according to an eighth modification example,

FIG. 27 is a conceptual diagram illustrating an example of window region position control processing according to a ninth modification example, and

FIG. 28 is a conceptual diagram illustrating an example of window region position control processing according to a tenth modification example.

### DETAILED DESCRIPTION

Hereinafter, an example of an imaging apparatus, an information processing method, and a program according to the present disclosed technology will be described with reference to the accompanying drawings.

First, the wording used in the following description will be described.

CPU refers to an abbreviation of a “Central Processing Unit”. GPU refers to an abbreviation of a “Graphics Processing Unit”. TPU refers to an abbreviation of a “Tensor processing unit”. NVM refers to an abbreviation of a “Non-volatile memory”. RAM refers to an abbreviation of a “Random Access Memory”. IC refers to an abbreviation of an “Integrated Circuit”. ASIC refers to an abbreviation of an “Application Specific Integrated Circuit”. PLD refers to an abbreviation of a “Programmable Logic Device”. FPGA refers to an abbreviation of a “Field-Programmable Gate Array”. SoC refers to an abbreviation of a “System-on-a-chip”. SSD refers to an abbreviation of a “Solid State Drive”. USB refers to an abbreviation of a “Universal Serial Bus”. HDD refers to an abbreviation of a “Hard Disk Drive”. EEPROM refers to an abbreviation of an “Electrically Erasable and Programmable Read Only Memory”. EL refers to an abbreviation of “Electro-Luminescence”. I/F refers to an abbreviation of an “Interface”. UI refers to an abbreviation of a “User Interface”. fps refers to an abbreviation of a “frame per second”. MF refers to an abbreviation of “Manual Focus”. AF refers to an abbreviation of “Auto Focus”. CMOS refers to an abbreviation of a “Complementary Metal Oxide Semiconductor”. CCD refers to an abbreviation of a “Charge Coupled Device”. A/D refers to an abbreviation of “Analog/Digital”. LUT refers to an abbreviation of “Lookup table”.

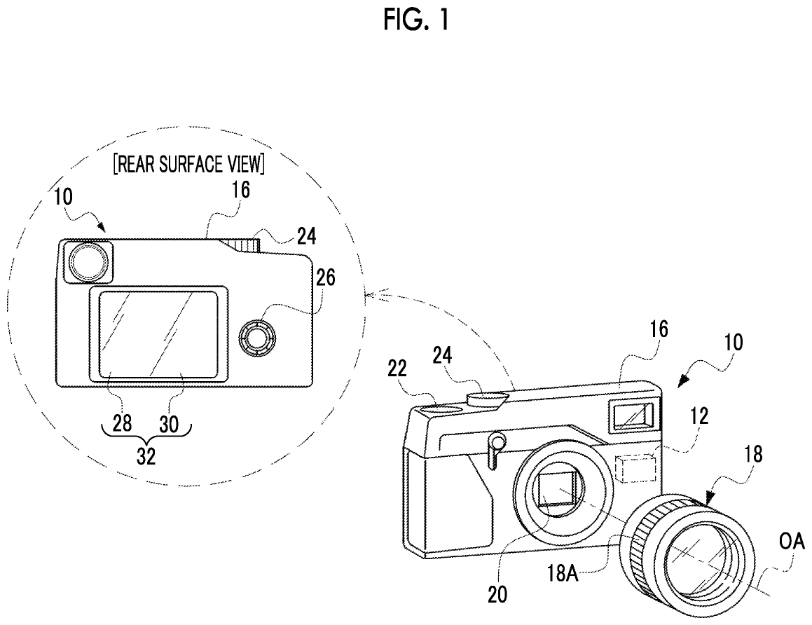

As an example shown in FIG. 1, the imaging apparatus 10 is an apparatus for imaging a subject and includes a processor 12, an imaging apparatus main body 16, and an interchangeable lens 18. The processor 12 is an example of a “computer” according to the present disclosed technology. The processor 12 is built into the imaging apparatus main body 16 and controls the entire imaging apparatus 10. The interchangeable lens 18 is interchangeably attached to the imaging apparatus main body 16. The interchangeable lens 18 is provided with a focus ring 18A. In a case where a user or the like of the imaging apparatus 10 (hereinafter, simply referred to as the “user”) manually adjusts the focus on the subject by the imaging apparatus 10, the focus ring 18A is operated by the user or the like.

In the example shown in FIG. 1, a lens-interchangeable digital camera is shown as an example of the imaging apparatus 10. However, this is only an example, and a digital camera with a fixed lens may be used or a digital camera, which is built into various electronic devices such as a smart device, a wearable terminal, a cell observation device, an ophthalmologic observation device, or a surgical microscope may be used.

An image sensor 20 is provided in the imaging apparatus main body 16. The image sensor 20 is an example of an “image sensor” according to the present disclosed technology. The image sensor 20 is a CMOS image sensor. The image sensor 20 captures an imaging area including at least one subject. In a case where the interchangeable lens 18 is attached to the imaging apparatus main body 16, subject light indicating the subject is transmitted through the interchangeable lens 18 and imaged on the image sensor 20, and then image data indicating an image of the subject is generated by the image sensor 20.

In the present embodiment, although the CMOS image sensor is exemplified as the image sensor 20, the present disclosed technology is not limited to this, for example, the present disclosed technology is established even in a case where the image sensor 20 is another type of image sensor such as a CCD image sensor.

A release button 22 and a dial 24 are provided on an upper surface of the imaging apparatus main body 16. The dial 24 is operated in a case where an operation mode of an imaging system, an operation mode of a playback system, and the like are set, and by operating the dial 24, an imaging mode, a playback mode, and a setting mode are selectively set as the operation mode in the imaging apparatus 10. The imaging mode is an operation mode in which the imaging is performed with respect to the imaging apparatus 10. The playback mode is an operation mode for playing the image (for example, a still image and/or a moving image) obtained by the performance of the imaging for recording in the imaging mode. The setting mode is an operation mode for setting the imaging apparatus 10 in a case where various set values used in the control related to the imaging are set.

The release button 22 functions as an imaging preparation instruction unit and an imaging instruction unit, and is capable of detecting a two-step pressing operation of an imaging preparation instruction state and an imaging instruction state. The imaging preparation instruction state refers to a state in which the release button 22 is pressed, for example, from a standby position to an intermediate position (half pressing position), and the imaging instruction state refers to a state in which the release button 22 is pressed to a final pressed position (fully pressing position) beyond the intermediate position. In the following, the “state of being pressed from the standby position to the half pressing position” is referred to as a “half pressing state”, and the “state of being pressed from the standby position to the full pressed position” is referred to as a “fully pressing state”. Depending on the configuration of the imaging apparatus 10, the imaging preparation instruction state may be a state in which the user's finger is in contact with the release button 22, and the imaging instruction state may be a state in which the operating user's finger is moved from the state of being in contact with the release button 22 to the state of being away from the release button 22.

An instruction key 26 and a touch panel display 32 are provided on a rear surface of the imaging apparatus main body 16.

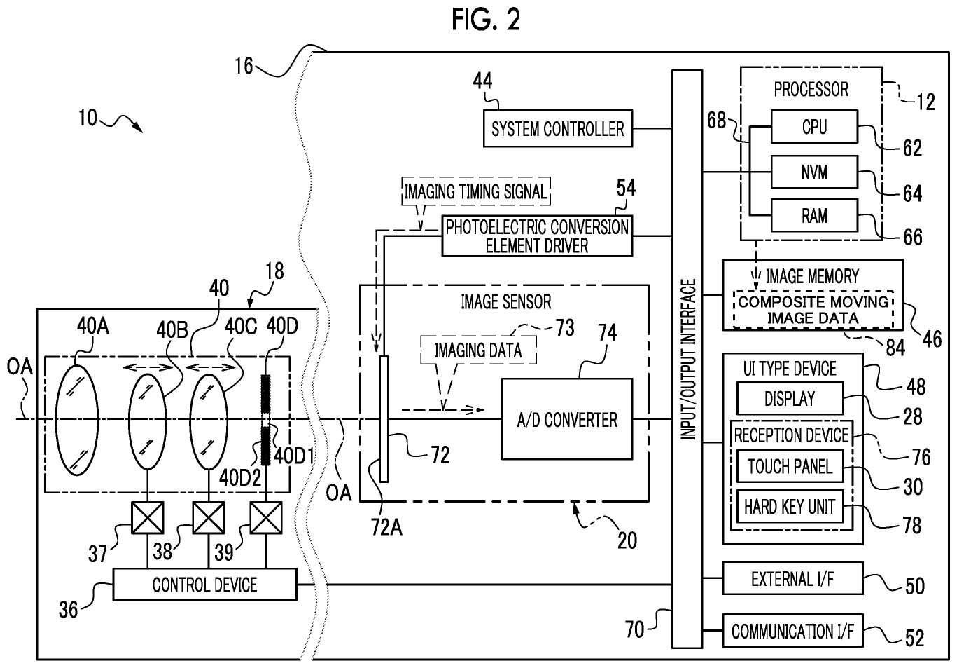

The touch panel display 32 includes a display 28 and a touch panel 30 (see also FIG. 2). Examples of the display 28 include an EL display (for example, an organic EL display or an inorganic EL display). The display 28 may not be an EL display but may be another type of display such as a liquid crystal display.

The display 28 displays image and/or character information and the like. The display 28 is used for imaging for a live view image, that is, for displaying a live view image obtained by performing the continuous imaging in a case where the imaging apparatus 10 is in the imaging mode. Here, the “live view image” refers to a moving image for display based on the image data obtained by being imaged by the image sensor 20. The imaging, which is performed to obtain the live view image (hereinafter, also referred to as “imaging for a live view image”), is performed according to, for example, a frame rate of 60 fps. 60 fps is only an example, and a frame rate of fewer than 60 fps may be used, or a frame rate of more than 60 fps may be used.

The display 28 is also used for displaying a still image obtained by the performance of the imaging for a still image in a case where an instruction for performing the imaging for a still image is provided to the imaging apparatus 10 via the release button 22. The display 28 is also used for displaying a playback image or the like in a case where the imaging apparatus 10 is in the playback mode. Further, the display 28 is also used for displaying a menu screen where various menus can be selected and displaying a setting screen for setting the various set values used in control related to the imaging in a case where the imaging apparatus 10 is in the setting mode.

The touch panel 30 is a transmissive touch panel and is superimposed on a surface of a display region of the display 28. The touch panel 30 receives the instruction from the user by detecting contact with an indicator such as a finger or a stylus pen. In the following, for convenience of explanation, the above-mentioned “fully pressing state” includes a state in which the user turns on a softkey for starting the imaging via the touch panel 30.

In the present embodiment, although an out-cell type touch panel display in which the touch panel 30 is superimposed on the surface of the display region of the display 28 is exemplified as an example of the touch panel display 32, this is only an example. For example, as the touch panel display 32, an on-cell type or in-cell type touch panel display can be applied.

The instruction key 26 receives various instructions. Here, the “various instructions” refer to, for example, various instructions such as an instruction for displaying the menu screen, an instruction for selecting one or a plurality of menus, an instruction for confirming a selected content, an instruction for erasing the selected content, zooming in, zooming out, frame forwarding, and the like. Further, these instructions may be provided by the touch panel 30.

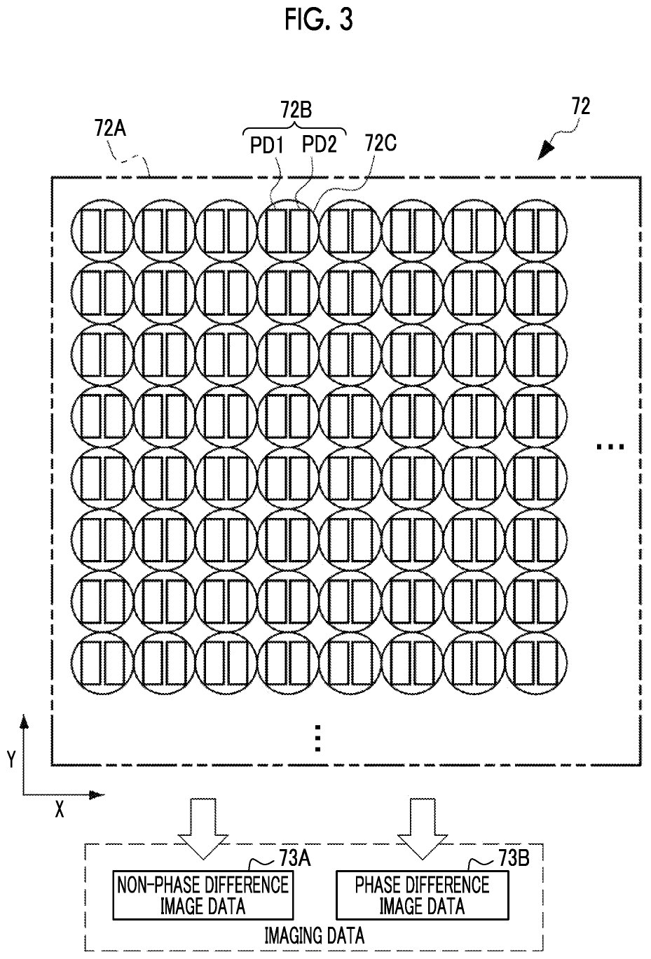

As an example shown in FIG. 2, the image sensor 20 includes photoelectric conversion elements 72. The photoelectric conversion elements 72 have a light-receiving surface 72A. The photoelectric conversion elements 72 are disposed in the imaging apparatus main body 16 such that the center of the light-receiving surface 72A and an optical axis OA coincide with each other (see also FIG. 1). The photoelectric conversion elements 72 have a plurality of photosensitive pixels 72B (see FIG. 3) arranged in a matrix shape, and the light-receiving surface 72A is formed by the plurality of photosensitive pixels. Each photosensitive pixel 72B has a micro lens 72C (see FIG. 3). The photosensitive pixel 72B is a physical pixel having a photodiode (not shown), which photoelectrically converts the received light and outputs an electric signal according to a light-receiving amount.

Further, red (R), green (G), or blue (B) color filters (not shown) are arranged in a matrix shape in a default pattern arrangement (for example, Bayer arrangement, G stripe R/G complete checkered pattern, X-Trans (registered trademark) arrangement, honeycomb arrangement, or the like) on the plurality of photosensitive pixels 72B.

In the following, for convenience of explanation, a photosensitive pixel 72B having a micro lens 72C and an R color filter is referred to as an R pixel, a photosensitive pixel 72B having a micro lens 72C and a G color filter is referred to as a G pixel, and a photosensitive pixel 72B having a micro lens 72C and a B color filter is referred to as a B pixel. Further, in the following, for convenience of explanation, the electric signal output from the R pixel is referred to as an “R signal”, the electric signal output from the G pixel is referred to as a “G signal”, and the electric signal output from the B pixel is referred to as a “B signal”.

The interchangeable lens 18 includes an imaging lens 40. The imaging lens 40 has an objective lens 40A, a focus lens 40B, a zoom lens 40C, and a stop 40D. The objective lens 40A, the focus lens 40B, the zoom lens 40C, and the stop 40D are disposed in the order of the objective lens 40A, the focus lens 40B, the zoom lens 40C, and the stop 40D along the optical axis OA from the subject side (object side) to the imaging apparatus main body 16 side (image side).

Further, the interchangeable lens 18 includes a control device 36, a first actuator 37, a second actuator 38, and a third actuator 39. The control device 36 controls the entire interchangeable lens 18 according to the instruction from the imaging apparatus main body 16. The control device 36 is a device having a computer including, for example, a CPU, an NVM, a RAM, and the like. The NVM of the control device 36 is, for example, an EEPROM. However, this is only an example, and an HDD and/or SSD or the like may be applied as the NVM of a system controller 44 instead of or together with the EEPROM. Further, the RAM of the control device 36 temporarily stores various types of information and is used as a work memory. In the control device 36, the CPU reads a necessary program from the NVM and executes the read various programs on the RAM to control the entire imaging lens 40.

Although a device having a computer is exemplified here as an example of the control device 36, this is only an example, and a device including an ASIC, FPGA, and/or PLD may be applied. Further, as the control device 36, for example, a device implemented by a combination of a hardware configuration and a software configuration may be used.

The first actuator 37 includes a slide mechanism for focus (not shown) and a motor for focus (not shown). The focus lens 40B is attached to the slide mechanism for focus so as to be slidable along the optical axis OA. Further, the motor for focus is connected to the slide mechanism for focus, and the slide mechanism for focus operates by receiving the power of the motor for focus to move the focus lens 40B along the optical axis OA.

The second actuator 38 includes a slide mechanism for zoom (not shown) and a motor for zoom (not shown). The zoom lens 40C is attached to the slide mechanism for zoom so as to be slidable along the optical axis OA. Further, the motor for zoom is connected to the slide mechanism for zoom, and the slide mechanism for zoom operates by receiving the power of the motor for zoom to move the zoom lens 40C along the optical axis OA.

The third actuator 39 includes a power transmission mechanism (not shown) and a motor for stop (not shown). The stop 40D has an opening 40D1 and is a stop in which the size of the opening 40D1 is variable. The opening 40D1 is formed by a plurality of stop leaf blades 40D2, for example. The plurality of stop leaf blades 40D2 are connected to the power transmission mechanism. Further, the motor for stop is connected to the power transmission mechanism, and the power transmission mechanism transmits the power of the motor for stop to the plurality of stop leaf blades 40D2. The plurality of stop leaf blades 40D2 receives the power that is transmitted from the power transmission mechanism and changes the size of the opening 40D1 by being operated. The stop 40D adjusts the exposure by changing the size of the opening 40D1.

The motor for focus, the motor for zoom, and the motor for stop are connected to the control device 36, and the control device 36 controls each drive of the motor for focus, the motor for zoom, and the motor for stop. In the present embodiment, a stepping motor is adopted as an example of the motor for focus, the motor for zoom, and the motor for stop. Therefore, the motor for focus, the motor for zoom, and the motor for stop operate in synchronization with a pulse signal in response to a command from the control device 36. Although an example in which the motor for focus, the motor for zoom, and the motor for stop are provided in the interchangeable lens 18 has been described here, this is only an example, and at least one of the motor for focus, the motor for zoom, or the motor for stop may be provided in the imaging apparatus main body 16. The constituent and/or operation method of the interchangeable lens 18 can be changed as needed.

In the imaging apparatus 10, in the case of the imaging mode, an MF mode and an AF mode are selectively set according to the instructions provided to the imaging apparatus main body 16. The MF mode is an operation mode for manually focusing. In the MF mode, for example, by operating the focus ring 18A or the like by the user, the focus lens 40B is moved along the optical axis OA with the movement amount according to the operation amount of the focus ring 18A or the like, thereby the focus is adjusted.

In the AF mode, the imaging apparatus main body 16 calculates a focusing position according to a subject distance and adjusts the focus by moving the focus lens 40B toward the calculated focusing position. Here, the focusing position refers to a position of the focus lens 40B on the optical axis OA in a state of being in focus.

The imaging apparatus main body 16 includes the image sensor 20, the processor 12, the system controller 44, an image memory 46, a UI type device 48, an external I/F 50, a communication I/F 52, a photoelectric conversion element driver 54, and an input/output interface 70. Further, the image sensor 20 includes the photoelectric conversion elements 72 and an A/D converter 74.

The processor 12, the image memory 46, the UI type device 48, the external I/F 50, the photoelectric conversion element driver 54, and the A/D converter 74 are connected to the input/output interface 70. Further, the control device 36 of the interchangeable lens 18 is also connected to the input/output interface 70.

The system controller 44 includes a CPU (not shown), an NVM (not shown), and a RAM (not shown). In the system controller 44, the NVM is a non-temporary storage medium and stores various parameters and various programs. The NVM of the system controller 44 is, for example, an EEPROM. However, this is only an example, and an HDD and/or SSD or the like may be applied as the NVM of a system controller 44 instead of or together with the EEPROM. Further, the RAM of the system controller 44 temporarily stores various types of information and is used as a work memory. In the system controller 44, the CPU reads a necessary program from the NVM and executes the read various programs on the RAM to control the entire imaging apparatus 10. That is, in the example shown in FIG. 2, the processor 12, the image memory 46, the UI type device 48, the external I/F 50, the communication I/F 52, the photoelectric conversion element driver 54, and the control device 36 are controlled by the system controller 44.

The processor 12 operates under the control of the system controller 44. The processor 12 includes a CPU 62, an NVM 64, and a RAM 66.

The CPU 62, the NVM 64, and the RAM 66 are connected via a bus 68, and the bus 68 is connected to the input/output interface 70. In the example shown in FIG. 2, one bus is shown as the bus 68 for convenience of illustration, but a plurality of buses may be used. The bus 68 may be a serial bus or may be a parallel bus including a data bus, an address bus, a control bus, and the like.

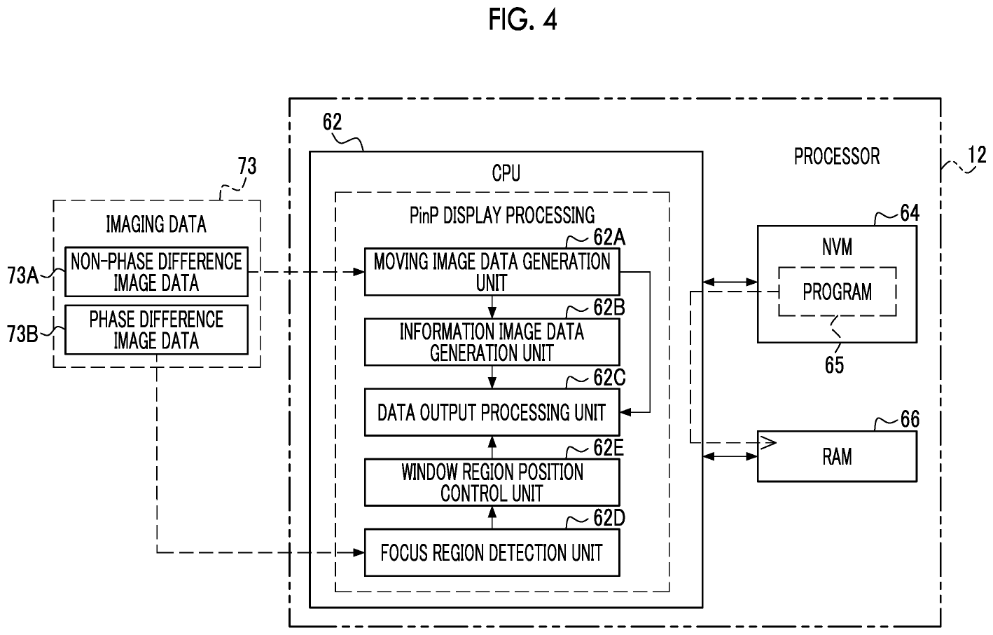

The NVM 64 is a non-temporary storage medium and stores various parameters and various programs, which are different from the various parameters and various programs stored in the NVM of the system controller 44. The various programs include a program 65 (see FIG. 4), which will be described later. For example, the NVM 64 is an EEPROM. However, this is only an example, and an HDD and/or SSD or the like may be applied as the NVM 64 instead of or together with the EEPROM. Further, the RAM 66 temporarily stores various types of information and is used as a work memory.

The CPU 62 reads a necessary program from the NVM 64 and executes the read program in the RAM 66. The CPU 62 performs image processing according to a program executed on the RAM 66.

The photoelectric conversion element driver 54 is connected to the photoelectric conversion elements 72. The photoelectric conversion element driver 54 supplies an imaging timing signal, which defines the timing of the imaging performed by the photoelectric conversion elements 72, to the photoelectric conversion elements 72 according to an instruction from the CPU 62. The photoelectric conversion elements 72 perform reset, exposure, and output of an electric signal according to the imaging timing signal supplied from the photoelectric conversion element driver 54. Examples of the imaging timing signal include a vertical synchronization signal, and a horizontal synchronization signal.

In a case where the interchangeable lens 18 is attached to the imaging apparatus main body 16, the subject light incident on the imaging lens 40 is imaged on the light-receiving surface 72A by the imaging lens 40. Under the control of the photoelectric conversion element driver 54, the photoelectric conversion elements 72 photoelectrically convert the subject light, which is received from the light-receiving surface 72A and output the electric signal corresponding to the amount of light of the subject light to the A/D converter 74 as imaging data 73 indicating the subject light. Specifically, the A/D converter 74 reads the imaging data 73 from the photoelectric conversion elements 72 in units of one frame and for each horizontal line by using an exposure sequential reading method.

The A/D converter 74 digitizes the analog imaging data 73 that is read from the photoelectric conversion element 72. The imaging data 73, which is digitized by the A/D converter 74, is so-called RAW image data, and represents an image in which R pixels, G pixels, and B pixels are arranged in a mosaic shape. Further, in the present embodiment, as an example, the number of bits of each of the R pixel, the B pixel, and the G pixel included in the RAW image data, that is, the length of the bits is 14 bits.

In the present embodiment, as an example, the CPU 62 of the processor 12 acquires the imaging data 73 from the A/D converter 74 and performs image processing on the acquired imaging data 73. In the present embodiment, the processor 12 generates moving image data 80 and information image data 82 based on the imaging data 73. The composite moving image data 84, which is generated by combining the moving image data 80 and the information image data 82, is stored in the image memory 46. In the present embodiment, the composite moving image data 84 is moving image data used for displaying the live view image.

The UI type device 48 comprises a display 28. The CPU 62 displays the composite moving image data 84, which is stored in the image memory 46, on the display 28. Further, the CPU 62 displays various types of information on the display 28.

Further, the UI type device 48 includes a reception device 76. The reception device 76 includes a touch panel 30 and a hard key unit 78. The hard key unit 78 is a plurality of hard keys including an instruction key 26 (see FIG. 1). The CPU 62 operates according to various instructions received by using the touch panel 30. Here, although the hard key unit 78 is included in the UI type device 48, the present disclosed technology is not limited to this, for example, the hard key unit 78 may be connected to the external I/F 50.

The external I/F 50 controls the exchange of various information between the imaging apparatus 10 and an apparatus existing outside the imaging apparatus 10 (hereinafter, also referred to as an “external apparatus”). Examples of the external I/F 50 include a USB interface. The external apparatus (not shown) such as a smart device, a personal computer, a server, a USB memory, a memory card, and/or a printer is directly or indirectly connected to the USB interface.

The communication I/F 52 is connected to a network (not shown). The communication I/F 52 controls the exchange of information between a communication device (not shown) such as a server on the network and the system controller 44. For example, the communication I/F 52 transmits information in response to a request from the system controller 44 to the communication device via the network. Further, the communication I/F 52 receives the information transmitted from the communication device and outputs the received information to the system controller 44 via the input/output interface 70.

As an example shown in FIG. 3, in the present embodiment, photosensitive pixels 72B, which includes a pair of independent photodiodes PD1 and PD2, are two-dimensionally arranged on a light-receiving surface 72A of the photoelectric conversion element 72. In FIG. 3, one direction that is parallel to the light-receiving surface 72A is defined as the X direction, and a direction orthogonal to the X direction is defined as the Y direction. The photosensitive pixels 72B are arranged along the X direction and the Y direction.

The photodiode PD1 performs photoelectric conversion on a luminous flux that passes through a first pupil portion region in the imaging lens 40. The photodiode PD2 performs photoelectric conversion on a luminous flux that passes through a second pupil portion region in the imaging lens 40. A color filter (not shown) and a micro lens 72C are disposed in each of the photosensitive pixels 72B.

The photoelectric conversion element 72 having a configuration shown in FIG. 3 is an image plane phase difference type photoelectric conversion element in which a pair of photodiodes PD1 and PD2 are provided for one pixel. In the present embodiment, the photoelectric conversion element 72 also has a function of outputting data that is related to the imaging and the phase difference by the photosensitive pixels 72B. In a case where the imaging is performed, the photoelectric conversion element 72 outputs the non-phase difference image data 73A by combining the pair of photodiodes PD1 and PD2 into one pixel. Further, in the AF mode, the photoelectric conversion element 72 outputs the phase difference image data 73B by detecting a signal from each of the pair of photodiodes PD1 and PD2.

That is, all the photosensitive pixels 72B, which are provided in the photoelectric conversion element 72 of the present embodiment, are so-called “phase difference pixels”. The photosensitive pixel 72B can selectively output the non-phase difference image data 73A in which the photoelectric conversion is performed in the entire region of the pixel and the phase difference image data in which the photoelectric conversion is performed in a part of the region of the pixel. Here, the “entire region of a pixel” is a light-receiving region in which the photodiode PD1 and the photodiode PD2 are combined to each other. Further, “a part of a region of a pixel” is a light-receiving region of the photodiode PD1 or a light-receiving region of the photodiode PD2.

The non-phase difference image data 73A can also be generated based on the phase difference image data 73B. For example, the non-phase difference image data 73A is generated by adding the phase difference image data 73B for each pair of pixel signals corresponding to the pair of photodiodes PD1 and PD2. Further, the phase difference image data 73B may include only data that is output from one of the pair of photodiodes PD1 or PD2. For example, in a case where the phase difference image data 73B includes only the data that is output from the photodiode PD1, it is possible to create data that is output from the photodiode PD2 by subtracting the phase difference image data 73B from the non-phase difference image data 73A for each pixel.

That is, the imaging data 73, which is read from the photoelectric conversion element 72, includes the non-phase difference image data 73A and/or the phase difference image data 73B. In the present embodiment, in the MF mode, a focus region in the imaging area is detected based on the phase difference image data 73B. A picture-in-picture display (hereinafter, referred to as a PinP display) described later is performed based on the detected focus region.

As an example shown in FIG. 4, the program 65 is stored in the NVM 64 of the imaging apparatus 10. The CPU 62 reads a program 65 from the NVM 64 and executes the read program 65 on the RAM 66. The CPU 62 performs PinP display processing according to a program 65 executed on the RAM 66. In the PinP display processing is implemented by the CPU 62 operates as a moving image data generation unit 62A, an information image data generation unit 62B, a data output processing unit 62C, a focus region detection unit 62D, and a window region position control unit 62E according to the program 65.

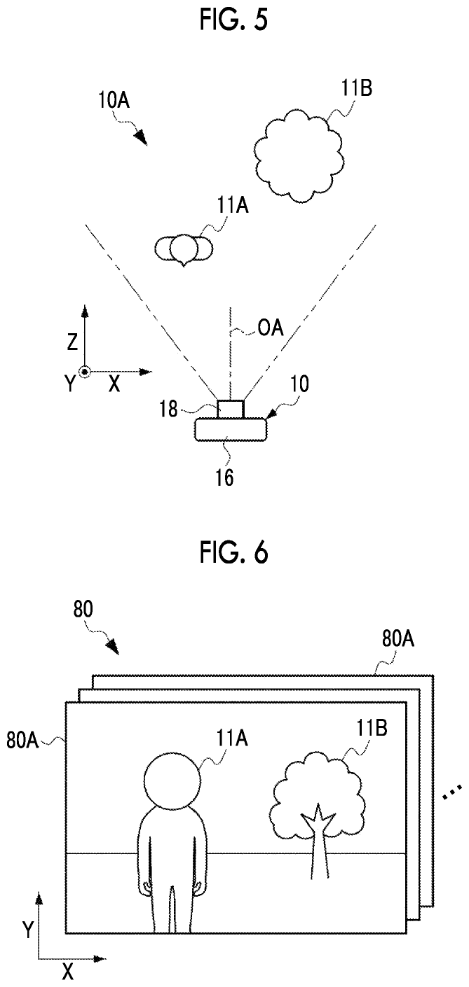

As an example shown in FIG. 5, the imaging is performed on the subject using the imaging apparatus 10. FIG. 5 is a bird's-eye view of the imaging area 10A obtained by the imaging apparatus 10 as viewed from above. In the example shown in FIG. 5, a person 11A and a tree 11B are present as subjects in the imaging area 10A. In FIG. 5, a direction that is parallel to the optical axis OA is defined as the Z direction. The Z direction is orthogonal to the X direction and the Y direction described above. In the example shown in FIG. 5, a distance between the person 11A and the tree 11B is different with respect to the imaging apparatus 10, and the tree 11B is located farther than the person 11A.

As an example shown in FIG. 6, the moving image data generation unit 62A generates the moving image data 80 that includes a plurality of frames 80A, based on the non-phase difference image data 73A (see FIG. 4) obtained by the image sensor 20 performing an imaging operation. In the example shown in FIG. 6, two subjects, which are the person 11A and the tree 11B, are captured in each frame 80A.

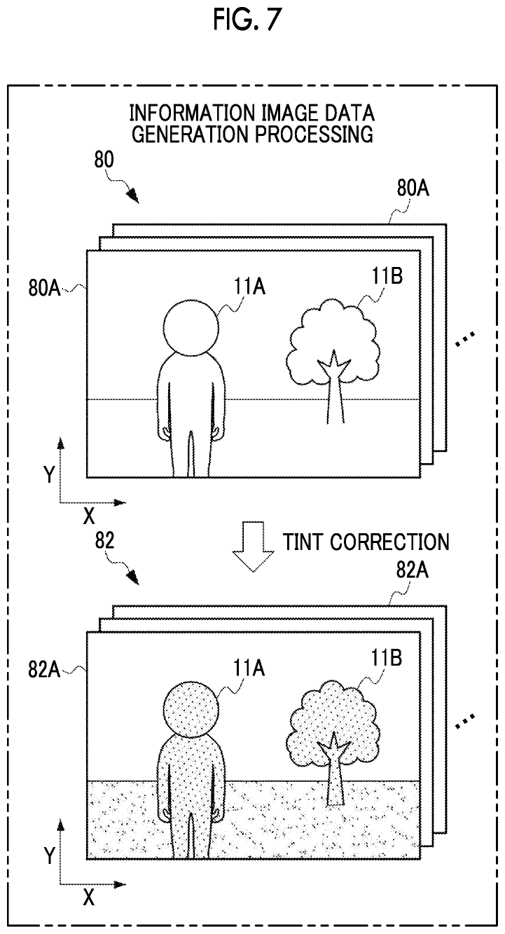

The information image data generation unit 62B generates the information image data 82 that represents information related to the moving image data 80, based on the moving image data 80 generated by the moving image data generation unit 62A. As an example shown in FIG. 7, the information image data generation unit 62B generates the information image data 82, which is moving image data consist of the plurality of frames 82A where tint correction is performed, by performing the tint correction on each frame 80A of the moving image data 80.

The information image data generation unit 62B is not limited to perform the tint correction, and may generate the information image data 82 by applying LUT for performing color matching with respect to the moving image data 80. Further, the information image data 82 is not limited to the data obtained by correcting the moving image data 80, and may be a histogram that represents the brightness of the image or a waveform that represents the brightness of the image. As described above, the information image data 82 may be any data that represents information related to the moving image data 80.

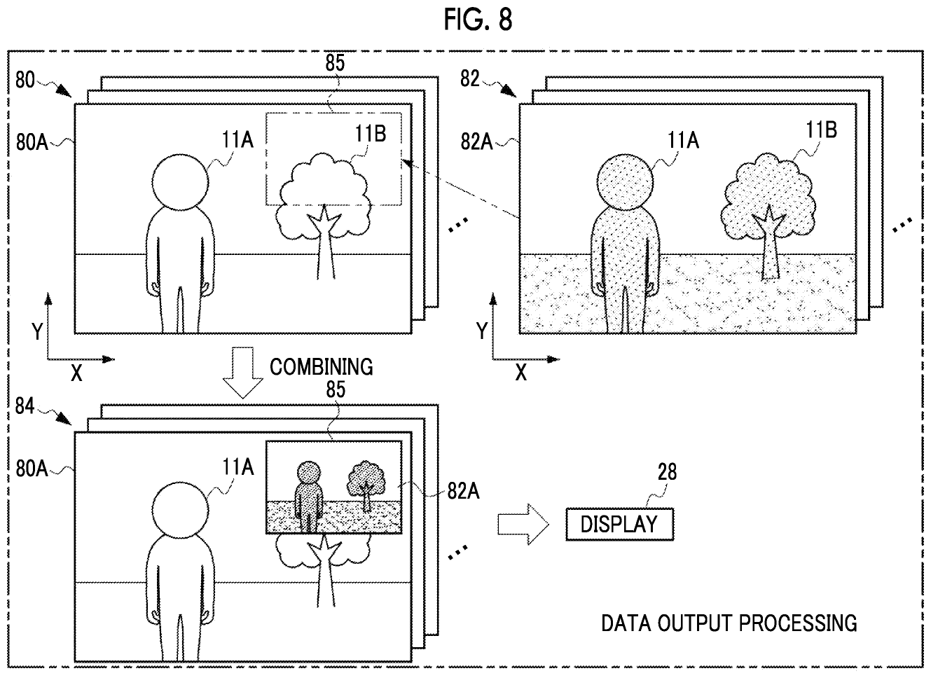

The data output processing unit 62C outputs the moving image data 80 and the information image data 82, which is associated with a window region 85 (see FIG. 8) in the image represented by the moving image data 80. As an example shown in FIG. 8, the data output processing unit 62C superimposes the information image data 82 on the window region 85 that is set as a rectangular region in a part of the frame 80A of the moving image data 80. Further, in the present embodiment, the data output processing unit 62C generates composite moving image data 84 by combining the moving image data 80 and the information image data 82 in a state in which the information image data 82 is superimposed on the window region 85 of the moving image data 80. The data output processing unit 62C outputs the composite moving image data 84 on the display 28 via the image memory 46 (see FIG. 2).

The display 28 is an example of a “display destination” according to the present disclosed technology. Further, the data output processing unit 62C is not limited to directly outputting the composite moving image data 84 to the display destination, and may indirectly output the composite moving image data 84 to the display destination via a relay apparatus or the like. Further, the data output processing unit 62C may directly or indirectly output the moving image data 80 and the information image data 82 to the display destination without generating the composite moving image data 84 in a state in which the information image data 82 is associated with the window region 85 of the moving image data 80.

The focus region detection unit 62D detects a focus region in the imaging area 10A based on the phase difference image data 73B. That is, the focus region detection unit 62D detects the focus region based on the imaging data 73 in a case where the photosensitive pixel 72B (see FIG. 3) as the phase difference pixel outputs the phase difference image data 73B.

Specifically, the focus region detection unit 62D acquires distance information at a plurality of positions within the imaging area 10A based on the phase difference image data 73B by detecting the phase difference (a deviation amount and a deviation direction) between an image, which is obtained based on a signal output from the photodiode PD1, and an image, which is obtained based on a signal output from the photodiode PD2. In the present embodiment, since the image plane phase difference type photoelectric conversion element 72 in which the pair of photodiodes is provided for one pixel is used, a distance can be acquired for a position corresponding to each of the photosensitive pixels 72B. The focus region detection unit 62D can detect a region of the subject (that is, the focus region) in an in-focus state, based on the distance information at the plurality of positions in the imaging area 10A.

For example, the focus region detection unit 62D detects the focus region from the frame 80A each time the moving image data generation unit 62A generates one frame 80A, based on the phase difference image data 73B corresponding to the generated frame 80A.

The window region position control unit 62E controls the position of the window region 85 according to the focus region detected by the focus region detection unit 62D. In the present embodiment, the window region position control unit 62E sets the position of the window region 85 in a region that does not overlap the focus region in each frame 80A of the moving image data 80.

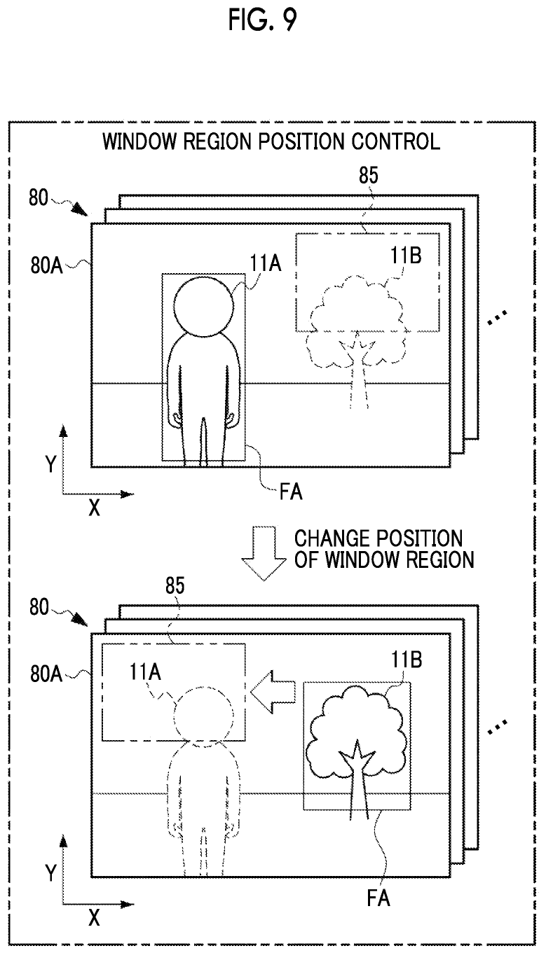

As an example shown in FIG. 9, in a case where a region including the person 11A is detected as the focus region FA, the window region position control unit 62E sets the position of the window region 85 so as not to overlap the person 11A in the in-focus state in the frame 80A. For example, the window region position control unit 62E sets the window region 85 at a position overlapping the tree 11B in an out-of-focus state. The window region position control unit 62E may reduce the size of the window region 85 so as not to overlap the focus region FA. In the present disclosure, “changing a position of a window region” also includes changing the size of the window region.

In FIG. 9, the subject in the in-focus state is represented by a solid line, and the subject in the out-of-focus state is represented by a broken line. The same applies to the following.

Thereafter, in a case where the user manually performs focus adjustment such that the tree 11B is in focus, a region including the tree 11B is detected as the focus region FA instead of the person 11A. In this case, the window region position control unit 62E changes the position of the window region 85 so as not to overlap the tree 11B in the in-focus state. For example, in the example shown in FIG. 9, the window region position control unit 62E changes the position of the window region 85 to a position overlapping the person 11A in the out-of-focus state.

The data output processing unit 62C described above superimposes the information image data 82 on the position of the window region 85 set by the window region position control unit 62E in each frame 80A of the moving image data 80. Accordingly, on the display 28 as the display destination, in each frame 80A of the moving image data 80, the information image data 82 is displayed in PinP so as not to overlap the focus region FA.

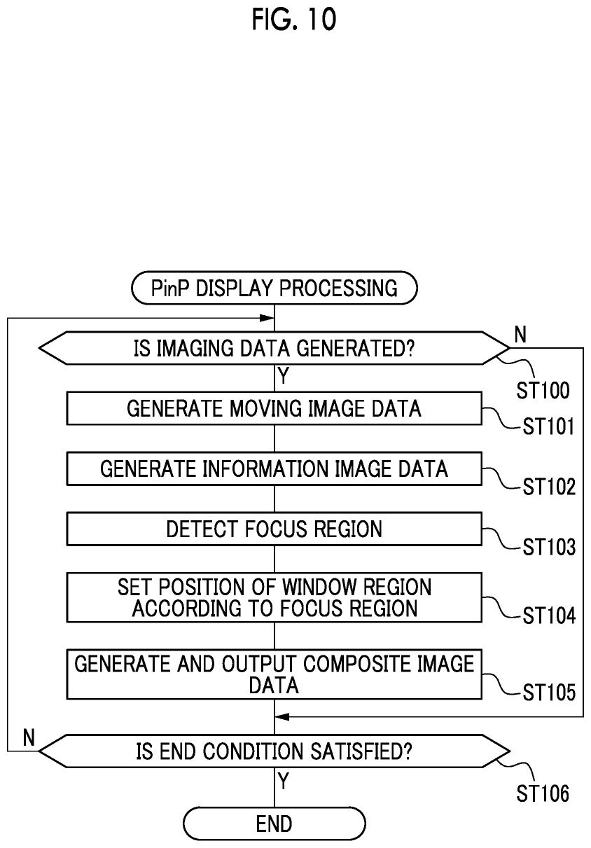

Next, the operation of the imaging apparatus 10 will be described with reference to FIG. 10. FIG. 10 shows an example of a flow of the PinP display processing executed by the CPU 62. The PinP display processing shown in FIG. 10 is executed, for example, during the display of the live view image before an imaging instruction is provided through the release button 22 in the MF mode.

In the PinP display processing shown in FIG. 10, first, in step ST100, the moving image data generation unit 62A determines whether or not the imaging data 73 (see FIG. 3) is generated by the image sensor 20 (see FIG. 2). Here, the imaging data 73 includes the non-phase difference image data 73A and the phase difference image data 73B.

In a case where the imaging data 73 is not generated by the image sensor 20 in step ST100, the determination is set as negative, and the PinP display processing shifts to step ST106. In a case where the imaging data 73 is generated by the image sensor 20 in step ST100, the determination is set as positive, and the PinP display processing shifts to step ST101.

In step ST101, the moving image data generation unit 62A generates the moving image data 80 (see FIG. 6) based on the non-phase difference image data 73A included in the imaging data 73. After one frame 80A of the moving image data 80 is generated in step ST101, the PinP display processing shifts to step ST102.

In step ST102, the information image data generation unit 62B generates the information image data 82 that represents information related to the moving image data 80, based on the moving image data 80 generated by the moving image data generation unit 62A. In the present embodiment, the information image data generation unit 62B generates the information image data 82 by performing tint correction (see FIG. 7) on each frame 80A of the moving image data 80. After the information image data 82 is generated in step ST102, the PinP display processing shifts to step ST103.

In step ST103, the focus region detection unit 62D detects the focus region FA (see FIG. 9) within the imaging area 10A (that is, within the frame 80A) based on the phase difference image data 73B included in the imaging data 73. After the focus region FA is detected in step ST103, the PinP display processing shifts to step ST104.

In step ST104, the window region position control unit 62E sets the position of the window region 85 according to the focus region FA detected by the focus region detection unit 62D (see FIG. 9). In the present embodiment, the window region position control unit 62E sets the position of the window region 85 in a region that does not overlap the focus region FA. After the position of the window region 85 is set in step ST104, the PinP display processing shifts to step ST105.

In step ST105, the data output processing unit 62C outputs the moving image data 80 and the information image data 82 on the display 28 in a state in which the information image data 82 is superimposed on the window region 85 set in the frame 80A. In the present embodiment, the data output processing unit 62C outputs the composite moving image data 84 (see FIG. 8), which is generated by combining the moving image data 80 and the information image data 82, on the display 28. After the composite moving image data 84 is output in step ST105, the PinP display processing shifts to step ST106.

In step ST106, the CPU 62 determines whether or not a condition for ending (hereinafter, referred to as an “end condition”) the PinP display processing is satisfied. Examples of the end condition include a condition that it is detected that the imaging instruction has been given through the release button 22 (see FIG. 1). In step ST106, in a case where the end condition is not satisfied, the determination is set as negative, and the PinP display processing shifts to step ST100. In step ST106, in a case where the end condition is satisfied, the determination is set as positive, and the PinP display processing is ended.

As described above, in the imaging apparatus 10 according to the embodiment, since the position of the window region 85 is controlled so as not to overlap the focus region FA, a setting operation of the window region 85 by the user can be unnecessary, and the visibility of the focus region FA can be improved.

In the above embodiment, although the photoelectric conversion element 72 is an image plane phase difference type photoelectric conversion element in which a pair of photodiodes is provided in one pixel and all the photosensitive pixels 72B have a function of outputting data related to imaging and phase difference, all the photosensitive pixels 72B are not limited to having the function of outputting data related to imaging and a phase difference. The photoelectric conversion element 72 may include a photosensitive pixel that does not have a function of outputting data related to the imaging and a phase difference. Further, the photoelectric conversion element 72 is not limited to an image plane phase difference type photoelectric conversion element in which a pair of photodiodes is provided in one pixel, the photoelectric conversion element 72 may include imaging photosensitive pixels for acquiring the non-phase difference image data 73A and phase difference detection photosensitive pixels for acquiring the phase difference image data 73B. In this case, the phase difference pixel is provided with a light shielding member so as to light-receive on one of the first pupil portion region and the second pupil portion region.

Further, the focus region FA is not limited to a method of using a photoelectric conversion element having a phase difference pixel, and can also be detected based on imaging data obtained by a photoelectric conversion element that does not have a phase difference pixel. For example, it is possible to detect the focus region FA based on the contrast or contour information of the subject represented by the imaging data.

### First Modification Example

In order to expand a region where the window region 85 can be set in the frame 80A, the imaging apparatus 10 according to a first modification example detects the focus region FA using a part of the range within the depth of field as the focus determination range. Other configurations of the imaging apparatus 10 according to the first modification example are the same as the configurations of the imaging apparatus 10 according to the above embodiment.

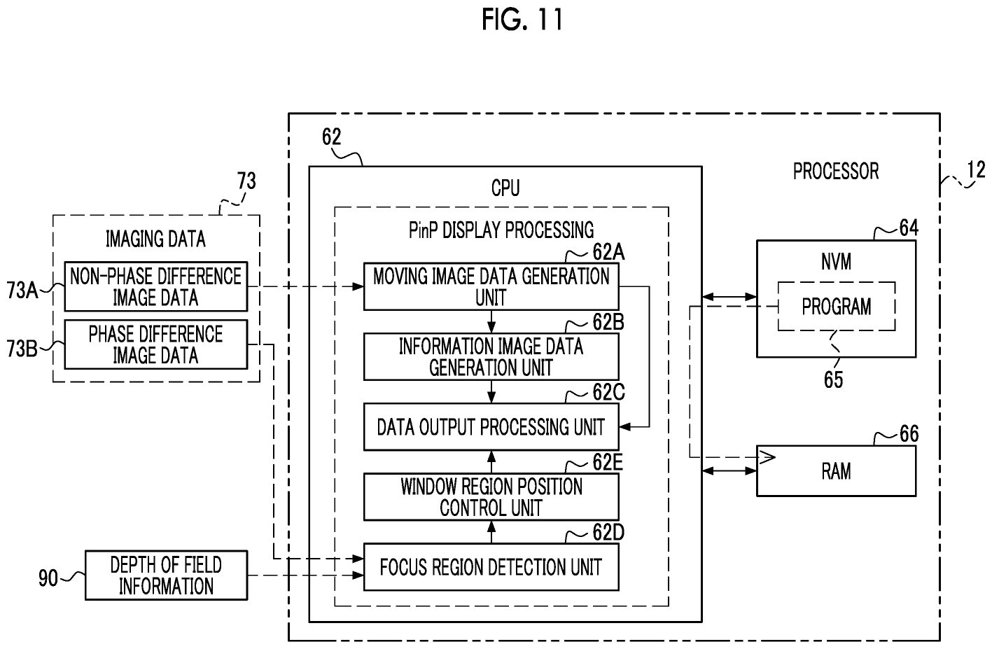

As an example shown in FIG. 11, in the first modification example, the focus region detection unit 62D acquires a depth of field information 90 from, for example, the system controller 44 in addition to the non-phase difference image data 73A. The depth of field information 90 is information that represents a rear side depth of field Lᵣ represented by Equation (1) and a front side depth of field L_{f} represented by Equation (2).

$${L}_{r} = \frac{δ {FL}^{2}}{{f}^{2} - δ FL} \qquad ( 1 )$$

$${L}_{f} = \frac{δ {FL}^{2}}{{f}^{2} + δ FL} \qquad ( 2 )$$

Where, f is a focal length, F is a stop value (that is, an F number) of the stop 40D, L is a focusing distance, and δ is an allowable confusion circle diameter. The allowable confusion circle diameter is substantially twice an arrangement pitch of the photosensitive pixel 72B, and a blurriness of a size of substantially one pixel is allowed. The focusing distance L is a distance from the light-receiving surface 72A of the photoelectric conversion element 72 included in the image sensor 20 to the subject in the in-focus state.

For example, the depth of field information 90 includes values of the rear side depth of field Lᵣ and the front side depth of field L_{f}. The depth of field information 90 may include values of the focal length f, the F number, the focusing distance L, and the allowable confusion circle diameter δ, respectively. In this case, the focus region detection unit 62D may calculate the rear side depth of field Lᵣ and the front side depth of field L_{f} based on the above Equations (1) and (2).

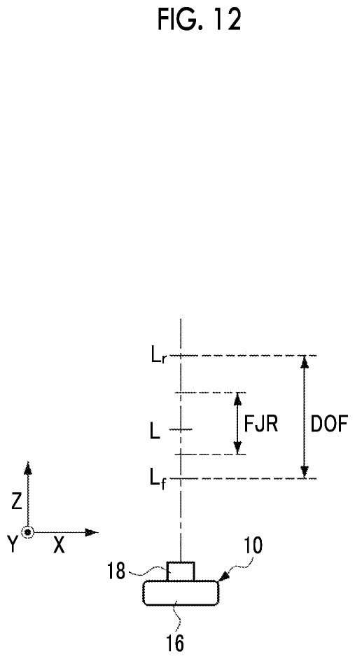

As an example shown in FIG. 12, a depth of field DOF represents a range from the front side depth of field L_{f} to the rear side depth of field Lᵣ along the Z direction. The depth of field DOF becomes larger (that is, deeper) as the F number is larger.

The focus region detection unit 62D detects the focus region FA using a part of the range within the depth of field DOF as the focus determination range FJR. That is, the focus region detection unit 62D detects the subject, which is present within the focus determination range FJR, based on the non-phase difference image data 73A and sets the detected region of the subject as the focus region FA.

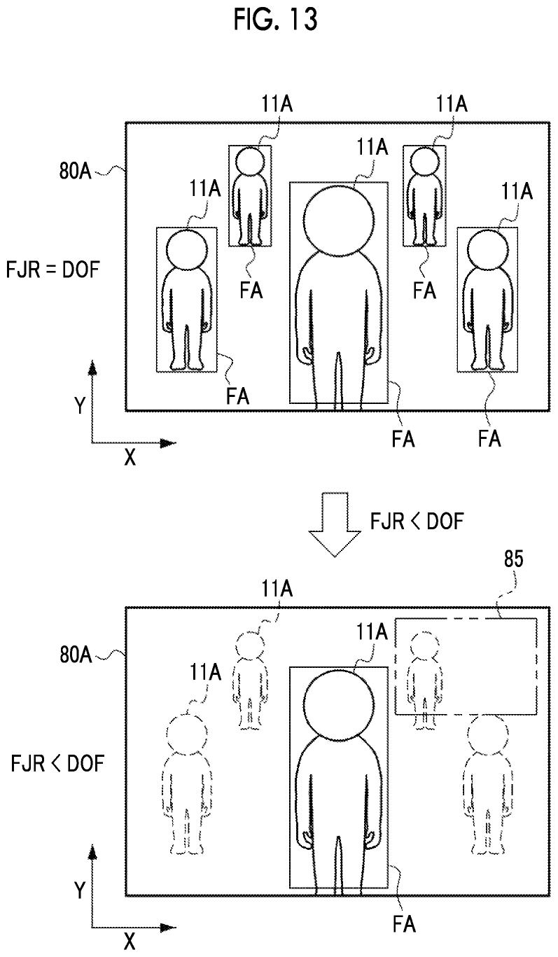

In a case where the F number is large (for example, in a case where the F number is 22), the entire range in the Z direction is within the depth of field DOF, and substantially all the regions within the frame 80A may be the focus region FA. In such a case, the window region 85 cannot be set at a position that does not overlap the focus region FA. As an example shown in FIG. 13, for example, FJR=DOF, and a case is assumed in which the window region 85 cannot be set at a position that does not overlap the focus regions FA due to the fact that a large number of focus regions FA are detected within the frame 80A.

Even in such cases, since the number of focus regions FA, which are detected within the frame 80A, is reduced by setting FJR<DOF, it is possible to set the window region 85 at a position that does not overlap the focus region FA. That is, a region, where the window region 85 can be set, can be expanded by setting FJR<DOF.

The focus determination range FJR may be a fixed value. For example, a range of ±1 m with respect to the focusing distance L may be set as the focus determination range FJR. However, since the depth of field DOF is changed based on the F number, in a case where the focus determination range FJR is set to a fixed value, the user may feel uncomfortable with a relationship between the determination result of the focus region FA and the F number.

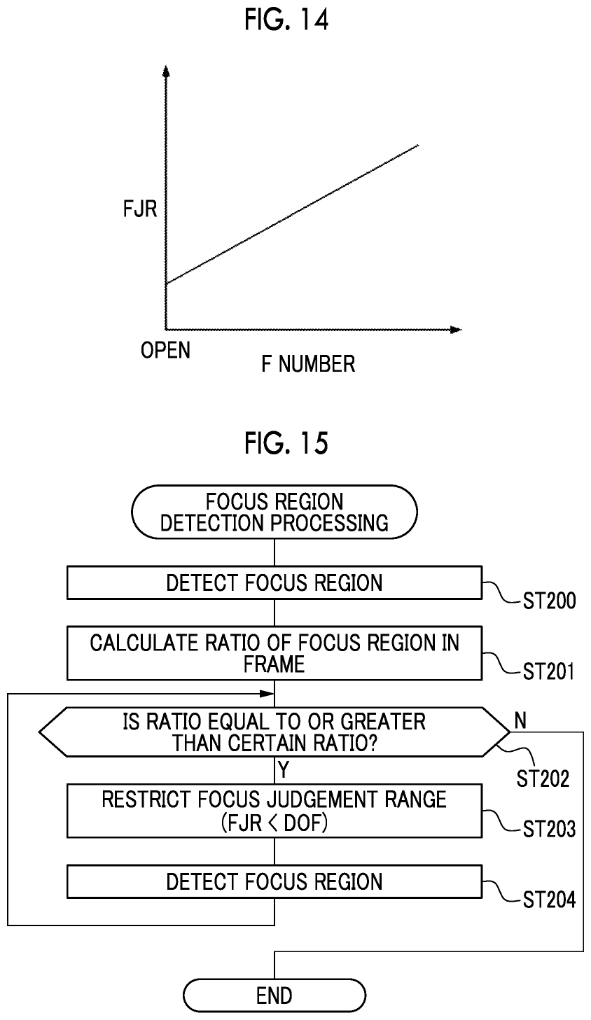

Therefore, as an example shown in FIG. 14, the focus determination range FJR may be changed based on the F number. For example, the larger the F number, the wider the focus determination range FJR. Further, the focus determination range FJR may be changed based on the depth of field DOF. For example, a range, which is reduced by multiplying the depth of field DOF by a certain ratio (for example, 10%) may be used as the focus determination range FJR. Further, the user may be able to set the focus determination range FJR by using the reception device 76 or the like.

Further, the focus region detection unit 62D may detect the focus region FA again using a part of the range within the depth of field DOF as the focus determination range FJR (that is, FJR<DOF) in a case where a region, which is equal to or greater than a certain ratio in the image represented by the moving image data 80 (that is, within the frame 80A), is the focus region FA.

In this case, the focus region detection unit 62D performs focus region detection processing shown in FIG. 15 as an example. First, in step ST200, the focus region detection unit 62D detects the focus region FA based on the phase difference image data 73B included in the imaging data 73. This step ST200 is the same as step ST103 (see FIG. 10) of the above-described embodiment, and FJR=DOF. After the focus region FA is detected in step ST200, the focus region detection processing shifts to step ST201.

In step ST201, the focus region detection unit 62D calculates a ratio of the focus region FA in the frame 80A. After the ratio of the focus region FA is calculated in step ST201, the focus region detection processing shifts to step ST202.

In step ST202, the focus region detection unit 62D determines whether or not the ratio of the focus region FA is equal to or greater than a certain ratio. In step ST202, in a case where the ratio of the focus region FA is less than a certain ratio, the determination is set as negative, and the focus region detection processing is ended. In step ST202, in a case where the ratio of the focus region FA is equal to or greater than a certain ratio, the determination is set as positive, and the focus region detection processing shifts to step ST203.

In step ST203, the focus region detection unit 62D restricts the focus determination range FJR to a part of the range within the depth of field DOC (that is, FJR<DOF). After FJR<DOF is set in step ST203, the focus region detection processing shifts to step ST204.

In step ST204, the focus region detection unit 62D detects the focus region FA again based on the phase difference image data 73B in a state in which FJR<DOF. After the focus region FA is detected in step ST204, the focus region detection processing shifts to step ST202.

In step ST202, the focus region detection unit 62D determines whether or not the ratio of the focus region FA is equal to or greater than a certain ratio again. In step ST202, in a case where the ratio of the focus region FA is less than a certain ratio, the determination is set as negative, and the focus region detection processing is ended. In step ST202, in a case where the ratio of the focus region FA is equal to or greater than a certain ratio, the determination is set as positive, and the focus region detection processing shifts to step ST203 again.

In step ST203, the focus region detection unit 62D restricts the focus determination range FJR to a narrower range. Thereafter, the focus region detection processing is repeatedly executed until the determination is set as negative in step ST202.

As described above, in the example shown in FIG. 15, in a case where substantially the entire image represented by the moving image data 80 is the focus region FA, the region, where the position of the window region 85 can be changed, is expanded by the focus region detection unit 62D by narrowing the focus determination range FJR.

### Second Modification Example

The imaging apparatus 10 according to the second modification example detects a distance of the subject and controls a state of the window region 85 according to a change direction of the detected distance of the subject. In particular, in the present modification example, the imaging apparatus 10 controls the position of the window region 85 in a case where at least one subject, which is present within the focus region, is moved in a going-away direction from the imaging apparatus 10 and becomes the out-of-focus state.

In the present modification example, the focus region detection unit 62D detects the movement of the subject in addition to the detection of the focus region FA based on the phase difference image data 73B corresponding to the plurality of frames 80A. The window region position control unit 62E controls the position of the window region 85 based on the movement direction of the subject.

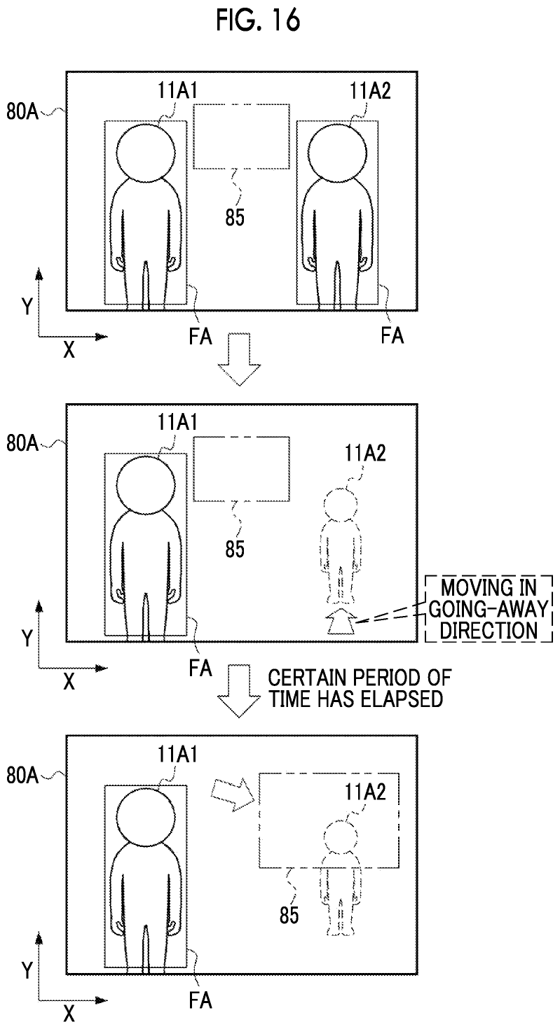

As an example shown in FIG. 16, in a case where two persons 11A1 and 11A2 are present in the focus region FA in the frame 80A, it is assumed that one person 11A2 is moved in the going-away direction from the imaging apparatus 10. In the present modification example, the focus region detection unit 62D detects that the person 11A2 is moved away from the imaging apparatus 10 and becomes the out-of-focus state.

Since the region, where the person 11A2 is present, is no longer in the focus region FA as the person 11A2, which was in the in-focus state, becomes the out-of-focus state, it is possible to move the window region 85 so as to overlap the person 11A2. However, the user may want to perform the focus adjustment so as to follow the distant person 11A2 instead of continuing to focus on the person 11A1 in the in-focus state. In this case, in a case where the window region position control unit 62E sets the window region 85 so as to overlap the person 11A2 in the out-of-focus state, the information image data 82, which is displayed in the window region 85, interferes with the focus adjustment with respect to the person 11A2.

Therefore, in the present modification example, in a case where the person 11A2, which is in the in-focus state, is moved in the going-away direction from the imaging apparatus 10 and becomes the out-of-focus state, the window region position control unit 62E moves the window region 85 after the out-of-focus state continues for a certain period of time without moving the window region 85 for a certain period of time (for example, 2 seconds). In the example shown in FIG. 16, the window region position control unit 62E moves the window region 85 and enlarges the window region 85.

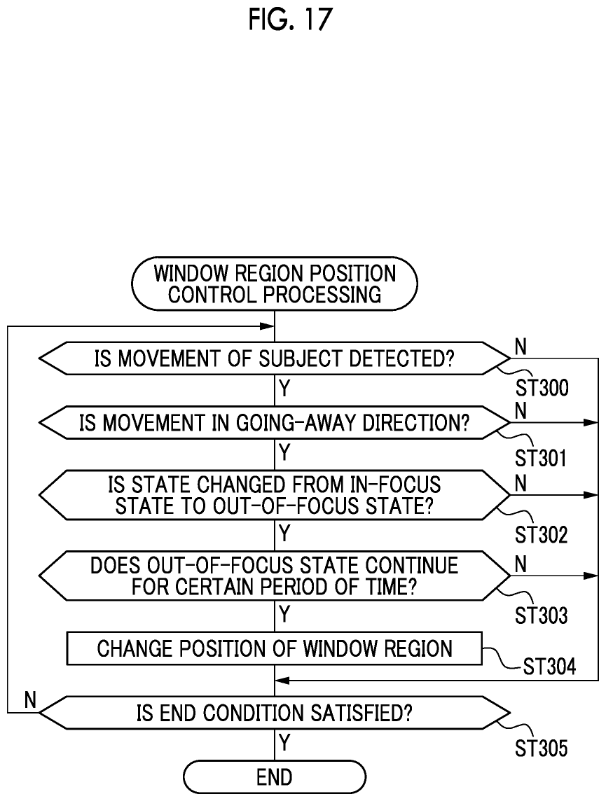

In the present modification example, the window region position control unit 62E performs the window region position control processing shown in FIG. 17 as an example. First, in step ST300, the window region position control unit 62E determines whether or not the movement of the subject is detected by the focus region detection unit 62D. In step ST300, in a case where the movement of the subject is not detected, the determination is set as negative, and the window region position control processing shifts to step ST305. In step ST300, in a case where the movement of the subject is detected, the determination is set as positive, and the window region position control processing shifts to step ST301.

In step ST301, the window region position control unit 62E determines whether or not the movement of the subject, which is detected by the focus region detection unit 62D, is a movement in the going-away direction. In step ST301, in a case where the movement is not in the going-away direction, the determination is set as negative, and the window region position control processing shifts to step ST305. In step ST301, in a case where the movement is in the going-away direction, the determination is set as positive, and the window region position control processing shifts to step ST302.

In step ST302, the window region position control unit 62E determines whether or not the state of the subject, which is detected by the focus region detection unit 62D, is changed from the in-focus state to the out-of-focus state. In step ST302, in a case where the subject is not in the out-of-focus state, the determination is set as negative, and the window region position control processing shifts to step ST305. In step ST302, in a case where the subject is in the out-of-focus state, the determination is set as positive, and the window region position control processing shifts to step ST303.

In step ST303, the window region position control unit 62E determines whether or not the out-of-focus state continues for a certain period of time. In step ST303, in a case where the out-of-focus state does not continue for a certain period of time, the determination is set as negative, and the window region position control processing shifts to step ST305. In step ST303, in a case where the out-of-focus state continues for a certain period of time, the determination is set as positive, and the window region position control processing shifts to step ST304.

In step ST304, the window region position control unit 62E changes the position of the window region 85 (see FIG. 16). After the position of the window region 85 is changed in step ST304, the window region position control processing shifts to step ST305.

In step ST305, the window region position control unit 62E determines whether or not a condition (hereinafter, referred to as an “end condition”) for ending the window region position control processing is satisfied. In step ST305, in a case where the end condition is not satisfied, the determination is set as negative, and the window region position control processing shifts to step ST300. In step ST305, in a case where the end condition is satisfied, the determination is set as positive, and the window region position control processing is ended.

As described above, in the present modification example, in a case where the focus region FA is changed as the subject, which is in the in-focus state, is moved in the going-away direction from the imaging apparatus 10 and becomes the out-of-focus state, the position of the window region 85 is not changed for a certain period of time. Accordingly, it is possible to suppress the information image data 82, which is displayed in the window region 85, from interfering with the focus adjustment.

### Third Modification Example

Similarly to the second modification example, the imaging apparatus 10 according to the third modification example detects a distance of the subject and controls a state of the window region 85 according to a change direction of the detected distance of the subject. In particular, in the present modification example, in a case where at least one subject, which is present in the focus region, is moved in the approaching direction to the imaging apparatus 10 and becomes the out-of-focus state, the imaging apparatus 10 erases the window region 85 for a certain period of time or increases the transmittance for a certain period of time.

In the present modification example, similarly to the second modification example, the focus region detection unit 62D detects the movement of the subject in addition to the detection of the focus region FA. The window region position control unit 62E controls the position of the window region 85 based on the movement direction of the subject.

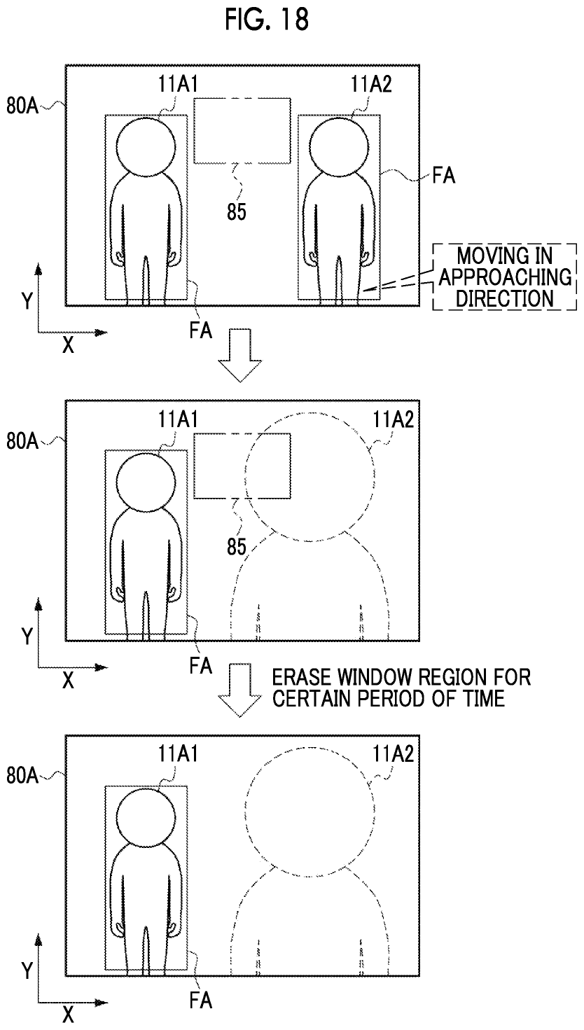

As an example shown in FIG. 18, in a case where two persons 11A1 and 11A2 are present in the focus region FA in the frame 80A, it is assumed that one person 11A2 is moved in the approaching direction to the imaging apparatus 10. In the present modification example, the focus region detection unit 62D detects that the person 11A2 approaches the imaging apparatus 10 and becomes the out-of-focus state.

Similarly to the case of the second modification example, the user may want to perform the focus adjustment on the approaching person 11A2 instead of continuing to focus on the person 11A1 in the in-focus state. However, as the person 11A2 approaches the imaging apparatus 10, the size of the person 11A2 increases, the window region 85 overlaps the person 11A2, and the information image data 82, which is displayed in the window region 85, interferes with the focus adjustment with respect to the person 11A2.

Therefore, in the present modification example, in a case where the person 11A2 is moved in the approaching direction to the imaging apparatus 10 and becomes the out-of-focus state, the window region position control unit 62E erases the window region 85 for a certain period of time (for example, 2 seconds). The transmittance of the window region 85 may be increased for a certain period of time instead of erasing the window region 85 for a certain period of time. In this case, the transmittance of the window region 85 is set to, for example, 0% to 70%. By increasing the transmittance of the window region 85, even in a case where the information image data 82 is displayed in the window region 85, an image of the person 11A2 in the region overlapping the window region 85 can be visible through the window region 85.

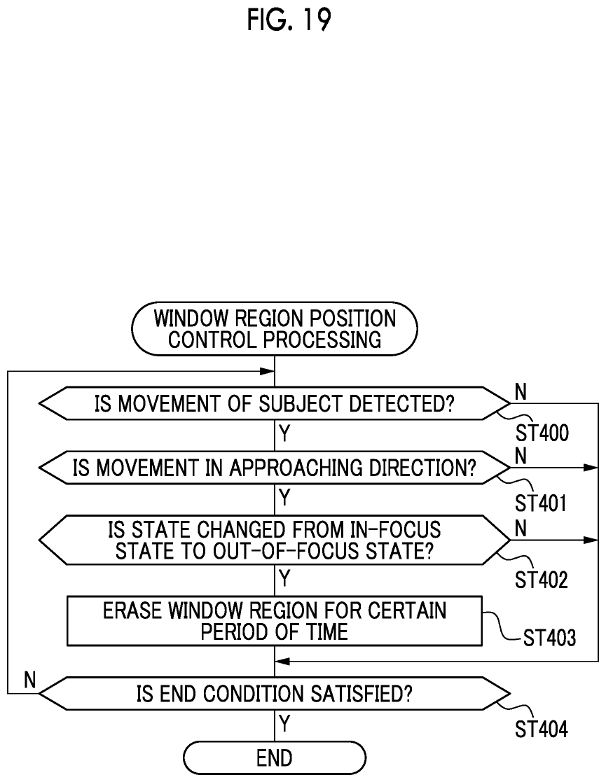

In the present modification example, the window region position control unit 62E performs the window region position control processing shown in FIG. 19 as an example. First, in step ST400, the window region position control unit 62E determines whether or not the movement of the subject is detected by the focus region detection unit 62D. In step ST400, in a case where the movement of the subject is not detected, the determination is set as negative, and the window region position control processing shifts to step ST404. In step ST400, in a case where the movement of the subject is detected, the determination is set as positive, and the window region position control processing shifts to step ST401.

In step ST401, the window region position control unit 62E determines whether or not the movement of the subject, which is detected by the focus region detection unit 62D, is a movement in the approaching direction. In step ST401, in a case where the movement is not in the approaching direction, the determination is set as negative, and the window region position control processing shifts to step ST404. In step ST401, in a case where the movement is in the approaching direction, the determination is set as positive, and the window region position control processing shifts to step ST402.

In step ST402, the window region position control unit 62E determines whether or not the state of the subject, which is detected by the focus region detection unit 62D, is changed from the in-focus state to the out-of-focus state. In step ST402, in a case where the subject is not in the out-of-focus state, the determination is set as negative, and the window region position control processing shifts to step ST404. In step ST402, in a case where the subject is in the out-of-focus state, the determination is set as positive, and the window region position control processing shifts to step ST403.

In step ST403, the window region position control unit 62E erases the window region 85 for a certain period of time (see FIG. 18). That is, the information image data 82 is not displayed for a certain period of time. After the window region 85 is erased for a certain period of time in step ST403, the window region position control processing shifts to step ST404.

In step ST404, the window region position control unit 62E determines whether or not the end condition is satisfied. In step ST404, in a case where the end condition is not satisfied, the determination is set as negative, and the window region position control processing shifts to step ST400. In step ST404, in a case where the end condition is satisfied, the determination is set as positive, and the window region position control processing is ended.

As described above, in the present modification example, in a case where the focus region FA is changed as the subject, which is in the in-focus state, is moved in the approaching direction to the imaging apparatus 10 and becomes the out-of-focus state, the window region 85 is erased for a certain period of time, or the transmittance is increased for a certain period of time. Accordingly, it is possible to suppress the information image data 82, which is displayed in the window region 85, from interfering with the focus adjustment.

### Fourth Modification Example

Similarly to the second and the third modification examples, the imaging apparatus 10 according to the fourth modification example detects a distance of the subject and controls a state of the window region 85 according to a change direction of the detected distance of the subject. In particular, in the present modification example, the imaging apparatus 10 does not change the position of the window region 85 for a certain period of time in a case where at least one subject, which is not present within the focus region, is moved in the approaching direction to the imaging apparatus 10 and becomes the in-focus state.

In the present modification example, similarly to the second and third modification examples, the focus region detection unit 62D detects the movement of the subject in addition to the detection of the focus region FA. The window region position control unit 62E controls the position of the window region 85 based on the movement direction of the subject.

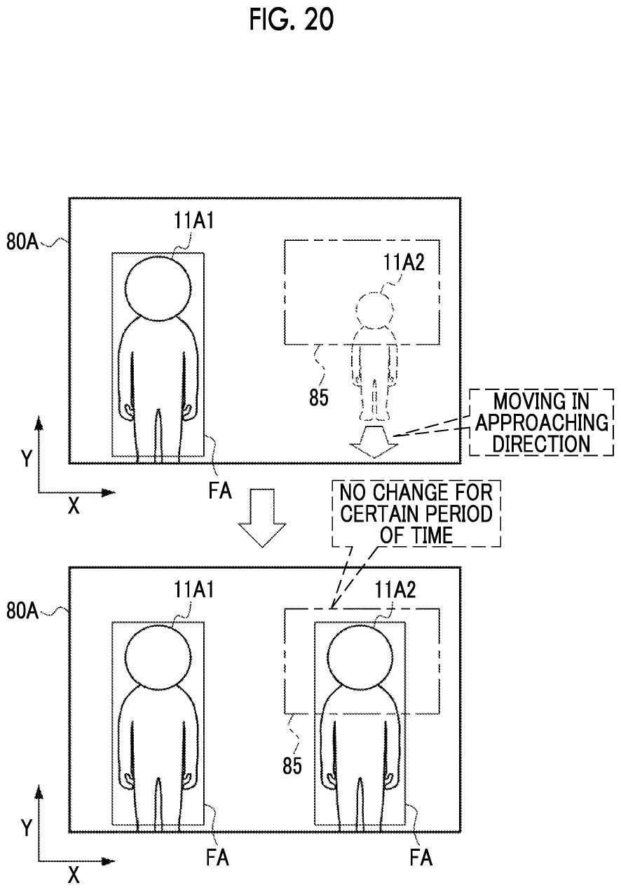

As an example shown in FIG. 20, it is assumed that, in the frame 80A, one person 11A2, among the two persons 11A1 and 11A2, which is not present in the focus region FA, is moved in the approaching direction to the imaging apparatus 10. In the present modification example, the focus region detection unit 62D detects that the person 11A2, which is in the out-of-focus state, approaches the imaging apparatus 10 and becomes the in-focus state.

Even in a case where the person 11A2, which was in the out-of-focus state, approaches and becomes the in-focus state, the person 11A2 is not necessarily the target subject that the user wants to image. In such a case, in a case where the window region 85 is moved and/or reduced by changing the focus region FA, the visibility of the information image data 82, which is displayed in the window region 85, may be decreased.

Therefore, in the present modification example, in a case where the person 11A2, which is in the out-of-focus state, is moved in the approaching direction to the imaging apparatus 10 and becomes the in-focus state, the window region position control unit 62E does not change the position of the window region 85 for a certain period of time (for example, 10 seconds). That is, the position of the window region 85 is changed after a certain period of time has elapsed. The certain period of time may be a period of time until the next operation (an MF operation, a zoom operation, a setting change operation such as white balance, or the like) is performed. Further, the certain period of time may be a period of time until an acceleration sensor or the like detects that an angle of view is changed.

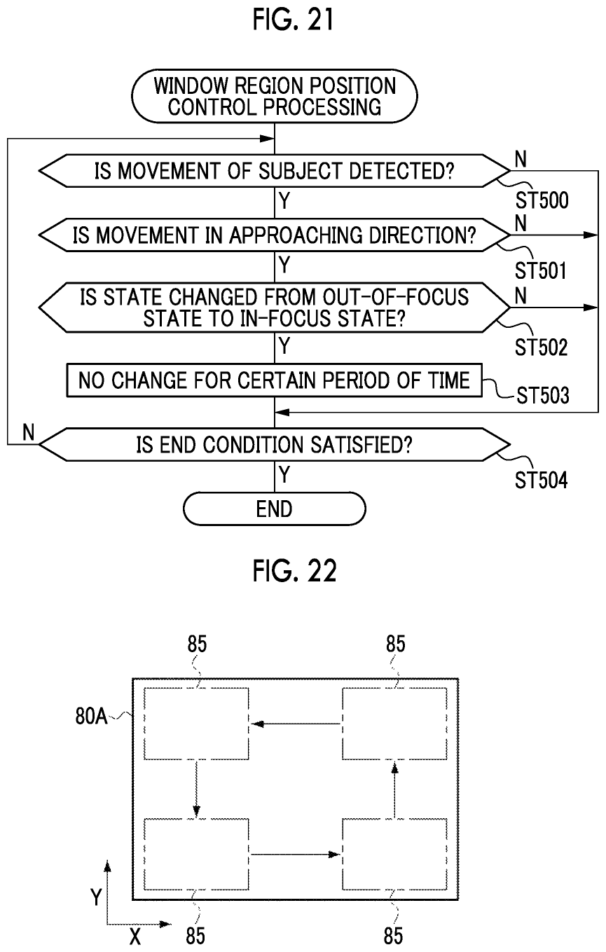

In the present modification example, the window region position control unit 62E performs the window region position control processing shown in FIG. 21 as an example. First, in step ST500, the window region position control unit 62E determines whether or not the movement of the subject is detected by the focus region detection unit 62D. In step ST500, in a case where the movement of the subject is not detected, the determination is set as negative, and the window region position control processing shifts to step ST504. In step ST500, in a case where the movement of the subject is detected, the determination is set as positive, and the window region position control processing shifts to step ST501.

In step ST501, the window region position control unit 62E determines whether or not the movement of the subject, which is detected by the focus region detection unit 62D, is a movement in the approaching direction. In step ST501, in a case where the movement is not in the approaching direction, the determination is set as negative, and the window region position control processing shifts to step ST504. In step ST501, in a case where the movement is in the approaching direction, the determination is set as positive, and the window region position control processing shifts to step ST502.

In step ST502, the window region position control unit 62E determines whether or not the state of the subject, which is detected by the focus region detection unit 62D, is changed from the out-of-focus state to the in-focus state. In step ST502, in a case where the subject is not in the in-focus state, the determination is set as negative, and the window region position control processing shifts to step ST504. In step ST502, in a case where the subject is in the in-focus state, the determination is set as positive, and the window region position control processing shifts to step ST503.

In step ST503, the window region position control unit 62E does not change the position of the window region 85 for a certain period of time (see FIG. 20). That is, the position of the window region 85 is changed after a certain period of time has elapsed. In step ST503, after a state, in which the position of the window region 85 is not changed for a certain period of time and the position is fixed, continues, the window region position control processing shifts to step ST504.

In step ST504, the window region position control unit 62E determines whether or not the end condition is satisfied. In step ST504, in a case where the end condition is not satisfied, the determination is set as negative, and the window region position control processing shifts to step ST500. In step ST504, in a case where the end condition is satisfied, the determination is set as positive, and the window region position control processing is ended.

As described above, in the present modification example, in a case where the focus region FA is changed as the subject, which is in the out-of-focus state, is moved in the approaching direction to the imaging apparatus 10 and becomes the in-focus state, the position of the window region 85 is not changed for a certain period of time. Accordingly, it is possible to suppress a change in the position of the window region 85 due to the focusing of a subject not intended by the user.

### Fifth Modification Example

Next, a modification example related to the change of the position of the window region 85 will be described. In the present modification example, as an example shown in FIG. 22, in a case of changing the position of the window region 85, the window region position control unit 62E changes the position of the window region 85 along the outer periphery of the image represented by the moving image data 80 (that is, the outer periphery of the frame 80A).

Since the focus region FA is often present near the center of the frame 80A, the visibility of the focus region FA is ensured by moving the window region 85 along the outer periphery of the frame 80A.

### Sixth Modification Example

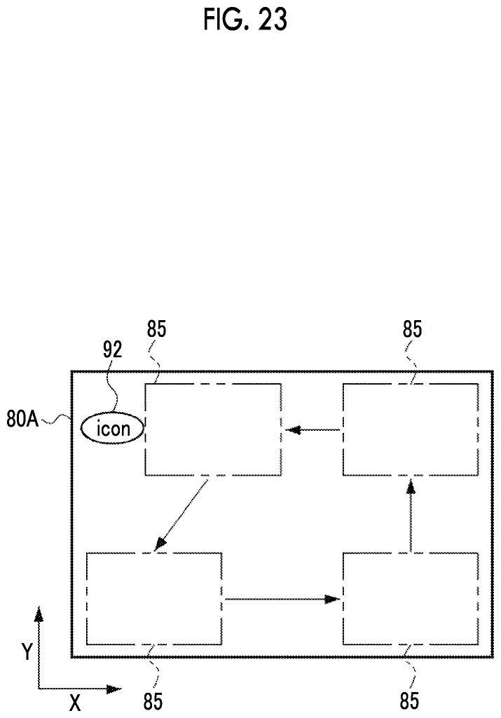

Next, a modification example related to the change of the position of the window region 85 in a case where an icon is displayed in the image represented by the moving image data 80 will be described. In the present modification example, as an example shown in FIG. 23, in a case where the icon 92 is displayed in the frame 80A, the window region position control unit 62E moves the window region 85 along a path avoiding the icon 92. Accordingly, the visibility of the icon 92 is prevented from being deteriorated due to the overlap of the window region 85.

For example, the icon 92 is a display image that represents various setting information (type of a focus mode, an F number, on/off of flash, and the like) of the imaging apparatus 10.

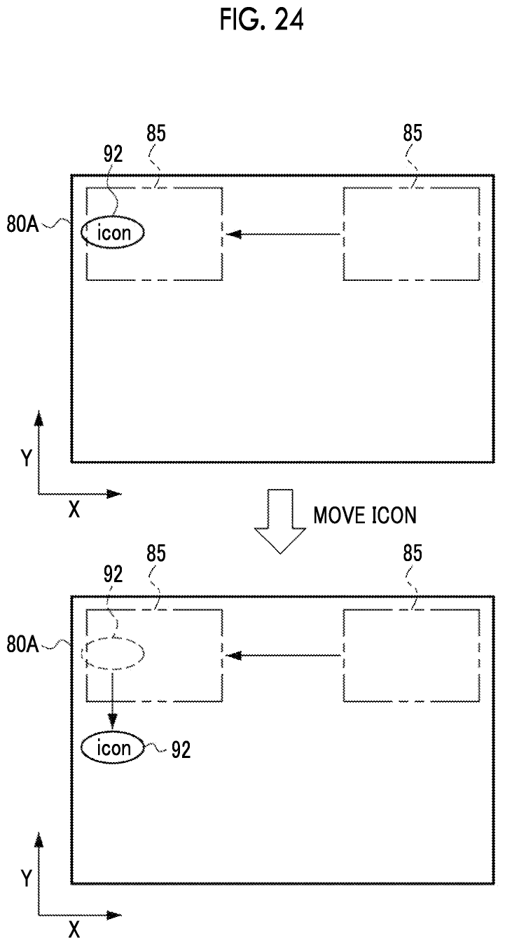

As another example shown in FIG. 24, in a case where the icon 92 is present on a path where the window region 85 is moved, the window region position control unit 62E may move the icon 92 out of the path where the window region 85 is moved.

### Seventh Modification Example

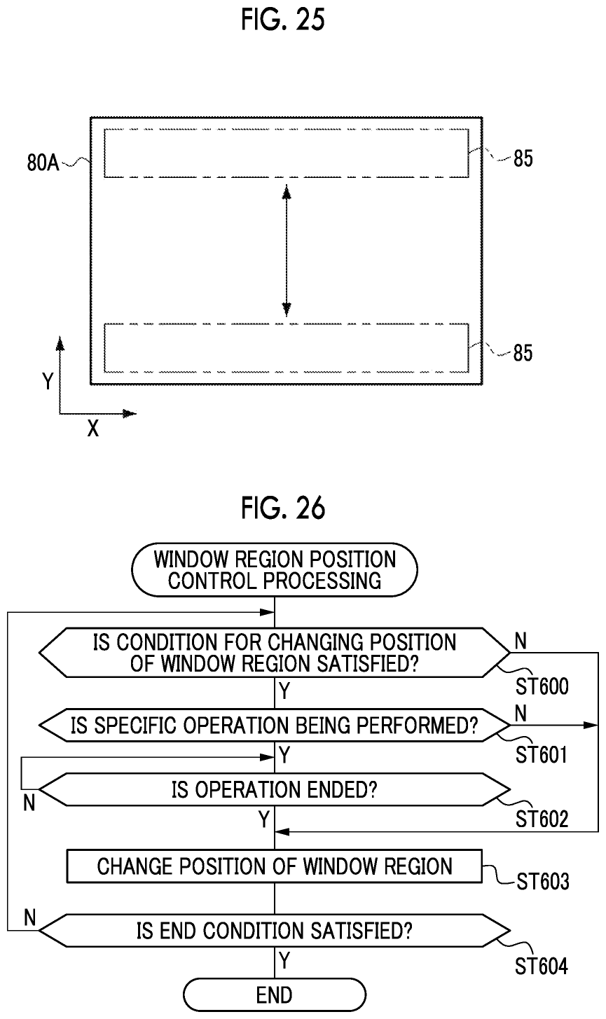

Next, a modification example related to a change of the position of the window region 85 in a case where the window region 85 has a shape extended along one side of the image represented by the moving image data 80 will be described. In the present modification example, as an example shown in FIG. 25, the window region 85 has a rectangular shape extending in the X direction, which is a long side direction of the frame 80A. In the present modification example, a histogram or a waveform obtained by plotting a brightness value related to the frame 80A in the Y direction is displayed as the information image data 82 in the window region 85.

In this case, the window region 85 cannot be moved in the X direction. Therefore, in a case where the shape of the window region 85 is changed and moved, the visibility of the histogram or the waveform which is displayed in the window region 85, is decreased. Therefore, in the present modification example, the window region position control unit 62E restricts a change direction of the position of the window region 85 to a direction intersecting a stretching direction of the window region 85. In the example shown in FIG. 25, the window region position control unit 62E restricts the change direction of the position of the window region 85 to the Y direction. The window region 85 may be stretched in the Y direction. In this case, the window region position control unit 62E restricts the change direction of the position of the window region 85 to the X direction.

### Eighth Modification Example

Next, an example will be described in which the change of the position of the window region 85 is prohibited in a case where the user is performing an operation on the imaging apparatus 10. In a case where the window region 85 is moved while the user is performing an operation such as a focus adjustment on the imaging apparatus 10, it is troublesome and may cause a hindrance to the operation. Therefore, in the present modification example, the window region position control unit 62E does not change the position of the window region 85 in a case where the specific operation is being performed by the user.

In the present modification example, the window region position control unit 62E performs the window region position control processing shown in FIG. 26 as an example. First, in step ST600, the window region position control unit 62E determines whether or not a condition for changing the position of the window region 85 is satisfied. For example, the window region position control unit 62E determines that the condition for changing the position of the window region 85 is satisfied in a case where the focus region FA is changed. In step ST600, in a case where the condition is not satisfied, the determination is set as negative, and the window region position control processing shifts to step ST603. In step ST600, in a case where the end condition is satisfied, the determination is set as positive, and the window region position control processing shifts to step ST601.

In step ST601, the window region position control unit 62E determines whether or not the specific operation is being performed on the imaging apparatus 10 by the user. In step ST601, in a case where the specific operation is not being performed, the determination is set as negative, and the window region position control processing shifts to step ST603. In step ST601, in a case where the specific operation is being performed, the determination is set as positive, and the window region position control processing shifts to step ST602.

In step ST602, the window region position control unit 62E determines whether or not the operation is ended. In step ST602, in a case where the operation is not ended, the determination is set as negative, and the window region position control processing executes step ST602 again. In step ST602, in a case where the operation is ended, the determination is set as positive, and the window region position control processing shifts to step ST603.

In step ST603, the window region position control unit 62E changes the position of the window region 85. After the position of the window region 85 is changed in step ST603, the window region position control processing shifts to step ST604.

In step ST604, the window region position control unit 62E determines whether or not the end condition is satisfied. In step ST604, in a case where the end condition is not satisfied, the determination is set as negative, and the window region position control processing shifts to step ST600. In step ST604, in a case where the end condition is satisfied, the determination is set as positive, and the window region position control processing is ended.

As described above, in the present modification example, since the position of the window region 85 is not changed in a case where the specific operation is being performed by the user, both the operability and the visibility of the window region 85 are compatible.

### Ninth Modification Example

Next, a case where the information image data 82 is peaking image data will be described. The peaking image data is image data in which a focus portion is emphasized and is generated by the information image data generation unit 62B. In the present modification example, the window region position control unit 62E sets the position of the window region 85 to a position that overlaps the focus region FA.

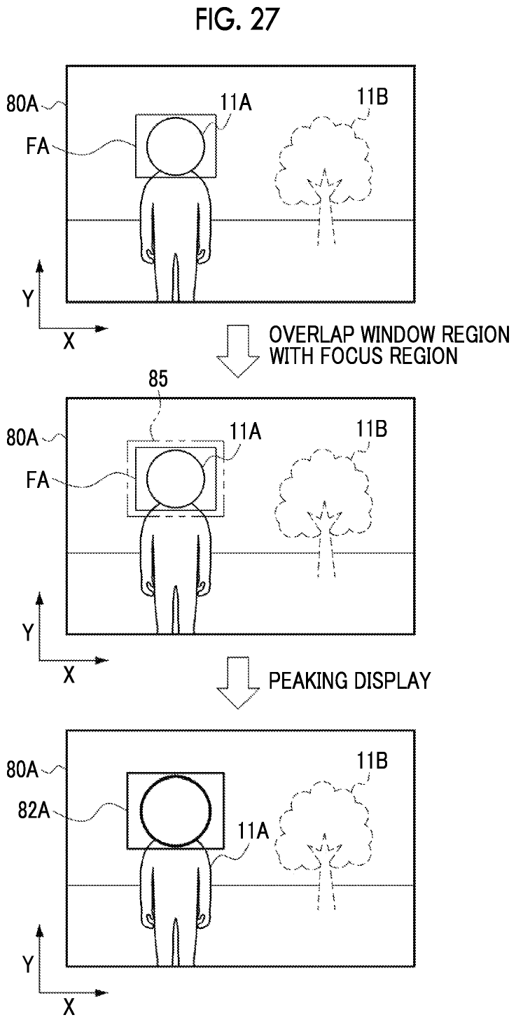

As an example shown in FIG. 27, it is assumed a case where a face portion of the person 11A is detected as the focus region FA. In this case, the window region position control unit 62E sets the position of the window region 85 to a position that overlaps the focus region FA. In the window region 85, the peaking image data in which the focus portion (for example, the contour) of the face portion of the person 11A is emphasized is displayed.

The size of the window region 85 may be changed according to the area of the focus region FA. In the example shown in FIG. 27, the window region 85 is enlarged such that the size of the face in the peaking image is larger than the size of the face of the person 11A in the frame 80A.

As described above, in a case where the information image data 82 is the peaking image data, as far as the peaking image is concerned, by setting the position of the window region 85 so as to overlap the focus region FA, the accuracy of focus confirmation by the user is improved.

### Tenth Modification Example

Next, a case will be described in which a region, which is equal to or greater than a certain ratio in the image represented by the moving image data 80, is the focus region FA, and the window region 85 cannot be set in a region that does not overlap the focus region FA. Although a region where the position of the window region 85 can be changed is expanded by narrowing the focus determination range FJR in the second modification example, in the present modification example, the window region 85 is set at a specific position within the frame 80A to increase the transmittance.

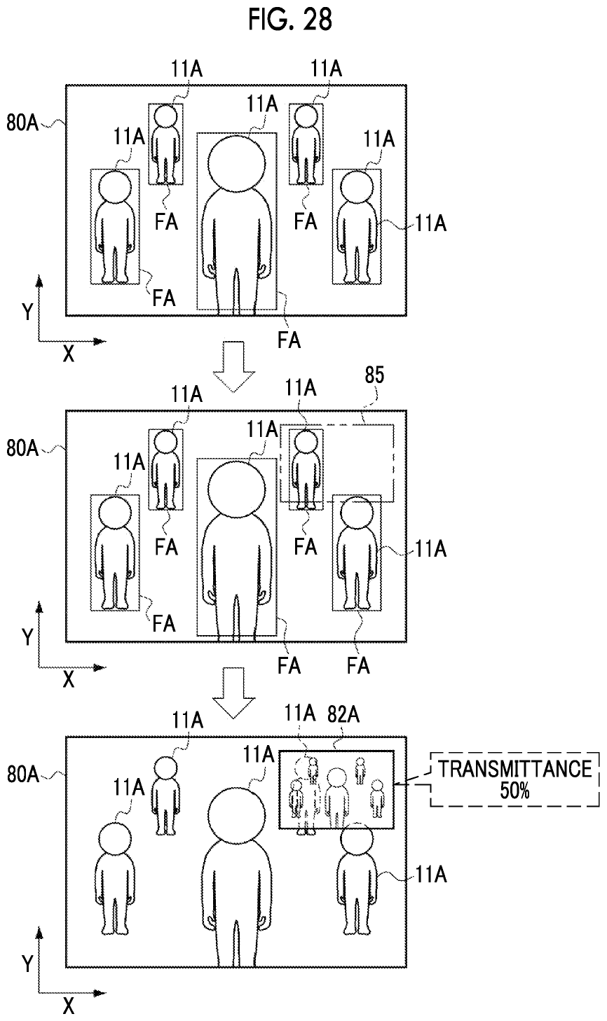

As an example shown in FIG. 28, a case is assumed in which the window region 85 cannot be set at a position that does not overlap the focus regions FA due to the fact that a large number of focus regions FA are detected within the frame 80A. In this case, in the present modification example, the window region position control unit 62E sets the window region 85 at a specific position (for example, a default position in the upper right corner) in the frame 80A. The transmittance of the window region 85 is changed from, for example, 0% to 50%. By increasing the transmittance of the window region 85, even in a case where the information image data 82 is displayed in the window region 85, an image of the person 11A in the region overlapping the window region 85 can be visible through the window region 85.

According to the present modification example, the visibility of the focus region FA can be ensured to a certain extent in a situation in which the window region 85 cannot be set so as not to overlap the focus region FA.

Although each of the above-described embodiments and the modification examples describe the PinP display processing performed during the display of the live view image in the MF mode, the PinP display processing of the present disclosure can also be applied to the AF mode.

Each of the above-mentioned embodiments and the modification examples can be combined with each other as long as no contradiction occurs.

Further, in the above embodiment, although the CPU 62 is exemplified, at least one other CPU, at least one GPU, and/or at least one TPU may be used instead of the CPU 62 or together with the CPU 62.

In the above embodiment, although an example of the embodiment in which the program 65 is stored in the NVM 64 has been described, the present disclosed technology is not limited to this. For example, the program 65 may be stored in a portable non-temporary storage medium such as an SSD or a USB memory. The program 65 stored in the non-temporary storage medium is installed in the processor 12 of the imaging apparatus 10. The CPU 62 executes the PinP display processing according to the program 65.

Further, the program 65 may be stored in the storage device such as another computer or a server device connected to the imaging apparatus 10 via the network, the program 65 may be downloaded in response to the request of the imaging apparatus 10, and the program 65 may be installed in the processor 12.

It is not necessary to store all of the programs 65 in the storage device such as another computer or a server device connected to the imaging apparatus 10, or the NVM 64, and a part of the program 65 may be stored.

Further, although the imaging apparatus 10 shown in FIG. 1 and FIG. 2 has a built-in processor 12, the present disclosed technology is not limited to this, for example, the processor 12 may be provided outside the imaging apparatus 10.

In the above embodiment, although the processor 12, which includes the CPU 62, NVM 64, and RAM 66, is exemplified, the present disclosed technology is not limited to this, and a device including an ASIC, FPGA, and/or PLD may be applied instead of the processor 12. Further, instead of the processor 12, a combination of a hardware configuration and a software configuration may be used.

As the hardware resource for executing the PinP display processing described in the embodiment above, the following various processors can be used. Examples of the processor include a CPU, which is a general-purpose processor that functions as the hardware resource for executing the PinP display processing by executing the software, that is, the program. Further, examples of the processor include a dedicated electric circuit, which is a processor having a circuit configuration specially designed for executing specific processing such as FPGA, PLD, or ASIC. A memory is also built in or connected to any processor, and any processor executes the PinP display processing by using the memory.

The hardware resource for executing the PinP display processing may be composed of one of those various processors or may be composed of a combination of two or more processors of the same type or different types (for example, a combination of a plurality of FPGAs or a combination of a CPU and an FPGA). Moreover, the hardware resource for executing the PinP display processing may be one processor.

As one example of the configuration with one processor, first, there is a form in which one processor is composed of a combination of one or more CPUs and software, and this processor functions as the hardware resource for executing the PinP display processing. Secondly, as typified by SoC, there is an embodiment in which a processor that implements the functions of the entire system including a plurality of hardware resources for executing the PinP display processing with one IC chip is used. As described above, the PinP display processing is realized by using one or more of the various processors described above as the hardware resources.

Further, as the hardware-like structure of these various processors, more specifically, an electric circuit in which circuit elements such as semiconductor elements are combined can be used. Moreover, the PinP display processing is merely an example. Therefore, it goes without saying that unnecessary steps may be deleted, new steps may be added, or the processing order may be changed within a range that does not deviate from the purpose.

The contents described above and the contents shown in the illustration are detailed explanations of the parts related to the present disclosed technology and are only an example of the present disclosed technology. For example, the description related to the configuration, function, action, and effect described above is an example related to the configuration, function, action, and effect of a portion according to the present disclosed technology. Therefore, it goes without saying that unnecessary parts may be deleted, new elements may be added, or replacements may be made to the contents described above and the contents shown in the illustration, within the range that does not deviate from the purpose of the present disclosed technology. Further, in order to avoid complications and facilitate understanding of the parts of the present disclosed technology, in the contents described above and the contents shown in the illustration, the descriptions related to the common technical knowledge or the like that do not require special explanation in order to enable the implementation of the present disclosed technology are omitted.

In the present specification, “A and/or B” is synonymous with “at least one of A or B”. That is, “A and/or B” means that it may be only A, it may be only B, or it may be a combination of A and B. Further, in the present specification, in a case where three or more matters are connected and expressed by “and/or”, the same concept as “A and/or B” is applied.

All documents, patent applications, and technical standards described in the present specification are incorporated in the present specification by reference to the same extent in a case where it is specifically and individually described that the individual documents, the patent applications, and the technical standards are incorporated by reference.

What is claimed is:

1. An imaging apparatus comprising:
an image sensor; and
a processor,
wherein the processor is configured to:
detect a focus region within an imaging area based on imaging data obtained by the image sensor;
generate moving image data based on the imaging data obtained by the image sensor;
generate information image data representing information related to the moving image data;
output the moving image data and the information image data, which is associated with a window region in an image represented by the moving image data; and
control a position of the window region according to the focus region.

2. The imaging apparatus according to claim 1,
wherein the processor is configured to output the moving image data and the information image data to a display destination.

3. The imaging apparatus according to claim 1,
wherein the processor is configured to
dispose the information image data in the window region and output composite moving image data generated by combining the moving image data and the information image data.

4. The imaging apparatus according to claim 1,
wherein the processor is configured to
set a position of the window region to a region that does not overlap the focus region.

5. The imaging apparatus according to claim 1,
wherein the processor is configured to
detect the focus region using a part of range within a depth of field as a focus determination range.

6. The imaging apparatus according to claim 5, further comprising:
a stop,
wherein the processor is configured to
set the focus determination range based on a stop value of the stop.

7. The imaging apparatus according to claim 1,
wherein the processor is configured to
detect the focus region again using a part of range within a depth of field as a focus determination range in a case where a region, which is equal to or greater than a certain ratio in the image represented by the moving image data, is the focus region.

8. The imaging apparatus according to claim 1,
wherein the processor is configured to
detect a distance from a subject based on the imaging data and control a state of the window region according to a change direction of the detected distance of the subject.

9. The imaging apparatus according to claim 8,
wherein the processor is configured not to
change the position of the window region for a certain period of time in a case where the focus region is changed as at least one subject, which is present within the focus region, is moved in a going-away direction and becomes an out-of-focus state.

10. The imaging apparatus according to claim 8,
wherein the processor is configured to
erase the window region for a certain period of time or increase a transmittance for a certain period of time in a case where the focus region is changed as at least one subject, which is present within the focus region, is moved in an approaching direction and becomes an out-of-focus state.

11. The imaging apparatus according to claim 8,
wherein the processor is configured not to
change the position of the window region for a certain period of time in a case where the focus region is changed as at least one subject, which is not present within the focus region, is moved in an approaching direction and becomes an in-focus state.

12. The imaging apparatus according to claim 1,
wherein the processor is configured to
change the position of the window region along an outer periphery of the image represented by the moving image data.

13. The imaging apparatus according to claim 1,
wherein the processor is configured to,
in a case where an icon is displayed in the image represented by the moving image data, move the window region along a path avoiding the icon or move the icon outside the path where the window region is moved.

14. The imaging apparatus according to claim 1,
wherein the processor is configured to
restrict a change direction of the position of the window region to a direction intersecting a stretching direction of the window region in a case where the window region has a shape stretching along one side of the image represented by the moving image data.

15. The imaging apparatus according to claim 1,
wherein the processor is configured not to
change the position of the window region while a specific operation is being performed.

16. The imaging apparatus according to claim 1,
wherein the information image data is data obtained by correcting the moving image data, a histogram representing a brightness, or a waveform representing a brightness.

17. The imaging apparatus according to claim 1,
wherein the processor is configured to
set the position of the window region to a position overlapping the focus region in a case where the information image data is peaking image data.

18. The imaging apparatus according to claim 17,
wherein the processor is configured to
change a size of the window region based on a size of the focus region.

19. The imaging apparatus according to claim 1,
wherein the window region is set at a specific position and is set to a state in which a transmittance is increased in a case where a region, which is equal to or greater than a certain ratio in the image represented by the moving image data, is the focus region, and the window region is not capable of being set to a region that does not overlap the focus region.

20. The imaging apparatus according to claim 1,
wherein the image sensor includes a plurality of phase difference pixels, and
the processor is configured to
detect the focus region based on, among the imaging data, imaging data that is obtained from the phase difference pixel.

21. The imaging apparatus according to claim 20,
wherein the phase difference pixel is capable of selectively outputting non-phase difference image data, which is obtained by performing photoelectric conversion in an entire region of a pixel, and phase difference image data, which is obtained by performing the photoelectric conversion in a part of region of the pixel, and
the processor is configured to
detect the focus region based on imaging data in a case where the phase difference pixel outputs the phase difference image data.

22. An information processing method comprising:
detecting a focus region within an imaging area based on imaging data obtained by an image sensor;
generating moving image data based on the imaging data obtained by the image sensor;
generating information image data representing information related to the moving image data;
outputting the moving image data and the information image data, which is associated with a window region in an image represented by the moving image data; and
controlling a position of the window region according to the focus region.

23. A non-transitory computer-readable storage medium storing a program causing a computer to execute a process comprising:
detecting a focus region within an imaging area based on imaging data obtained by an image sensor;
generating moving image data based on the imaging data obtained by the image sensor;
generating information image data representing information related to the moving image data;
outputting the moving image data and the information image data, which is associated with a window region in an image represented by the moving image data; and
controlling a position of the window region according to the focus region.
